(19) United States
(12) Patent Application Publication
(10) Pub. No.: US 2026/0105717 A1
(43) Pub. Date: Apr. 16, 2026

(54) IMAGE PROCESSING METHOD, ELECTRONIC DEVICE, AND STORAGE MEDIUM

(71) Applicant: Alibaba (China) Co., Ltd., Hangzhou (CN)

(72) Inventors: Jianpeng ZHANG, Hangzhou (CN); Ling ZHANG, Washington, DC (US); Le LU, Bethesda, MD (US); Jianfeng ZHANG, Hangzhou (CN); Yuxing Tang, Germantown, MD (US); Minfeng XU, Beijing (CN); Jianfei GUO, Hangzhou (CN); Jingren ZHOU, Bellevue, WA (US)

(21) Appl. No.: 19/419,601

(22) Filed: Dec. 15, 2025

Related U.S. Application Data
(63) Continuation of application No. PCT/CN2024/103723, filed on Jul. 4, 2024.

(30) Foreign Application Priority Data
Jul. 4, 2023 (CN) 202310814294.0

(51) Int. Cl. G06V 10/26; G06V 10/25; G06V 10/42; G06V 10/762; G06V 10/82; G06V 20/52

(52) U.S. Cl. CPC G06V 10/26; G06V 10/25; G06V 10/42; G06V 10/762; G06V 10/82; G06V 20/52

(57) ABSTRACT

An image processing method comprises: acquiring a plurality of images, wherein display content of the images comprises at least a monitoring region of a target part of an object to be monitored; performing semantic segmentation on the images to obtain a first region feature of the monitoring region in the images; determining a second region feature of the monitoring region based on a dependency relationship between a plurality of pre-constructed prototypes and the first region feature, wherein different prototypes are used to represent different types of monitoring regions; and identifying feature information of the monitoring region based on the first region feature and the second region feature to determine an identification result of the monitoring region. The present application solves the technical problem of low identification accuracy when identifying images to be monitored in related art.

### CROSS-REFERENCE TO RELATED APPLICATION

This application is a Continuation Application of International Patent Application No. PCT/CN2024/103723, filed on Jul. 4, 2024, which is based on and claims priority to and benefits of Chinese Patent Application No. 202310814294.0, filed with the China National Intellectual Property Administration on Jul. 4, 2023, and titled “Image Processing Method, Electronic Device, and Storage Medium”, the entire contents of which are incorporated herein by reference. The above-referenced applications are incorporated herein by reference in their entirety.

### TECHNICAL FIELD

This application relates to the field of image processing, and specifically, to an image processing method, an electronic device, and a storage medium.

### BACKGROUND

With the rapid development of science and technology, image processing technologies are increasingly applied in daily life, for example, in the medical field and the teaching field. In existing image processing methods, when processing a target part of an image, only feature extraction is performed on the image of the target part, and then the extracted features are recognized to obtain a recognition result. However, when the clarity of the image is low, the accuracy of the extracted features will be low, which in turn leads to low recognition accuracy when recognizing the target part in the image.

No effective solution has been proposed for the above-mentioned problem.

### SUMMARY

Embodiments of this application provide an image processing method, an electronic device, and a storage medium to at least solve the technical problem of low recognition accuracy when recognizing an image to be monitored in related art.

According to one aspect of an embodiment of this application, an image processing method is provided, comprising: acquiring a plurality of images, where the display content of the images at least comprises a monitoring region of a target part of an object to be monitored; performing semantic segmentation on the images to obtain a first region feature of the monitoring region in the images; determining a second region feature of the monitoring region based on a dependency relationship between a plurality of pre-constructed prototypes and the first region feature, where different prototypes are used to characterize different types of monitoring regions; and recognizing feature information of the monitoring region based on the first region feature and the second region feature to determine a recognition result of the monitoring region.

According to another aspect of an embodiment of this application, an image processing method is further provided, comprising: in response to an input instruction acting on an operation interface, displaying a plurality of images on the operation interface, where the display content of the images at least comprises a monitoring region of a target part of an object to be monitored; and in response to an image processing instruction acting on the operation interface, displaying a recognition result of the monitoring region on the operation interface, where the recognition result is obtained by recognizing feature information of the monitoring region based on a first region feature and a second region feature, the second region feature is determined based on a dependency relationship between a plurality of pre-constructed prototypes and the first region feature, and the first region feature is obtained by performing semantic segmentation on the medical images.

According to another aspect of an embodiment of this application, an image processing method is further provided, comprising: displaying a plurality of images on a presentation screen of a virtual reality (VR) device or an augmented reality (AR) device, where the display content of the images at least comprises a monitoring region of a target part of an object to be monitored; performing semantic segmentation on the images to obtain a first region feature of the monitoring region in the images; determining a second region feature of the monitoring region based on a dependency relationship between a plurality of pre-constructed prototypes and the first region feature, where different prototypes are used to characterize different types of monitoring regions; recognizing feature information of the monitoring region based on the first region feature and the second region feature to determine a recognition result of the monitoring region; and driving the VR device or the AR device to render and display the recognition result.

According to another aspect of an embodiment of this application, an image processing method is further provided, comprising: acquiring a plurality of images by calling a first interface, where the first interface comprises a first parameter, and a parameter value of the first parameter is the plurality of images, and the display content of the images at least comprises a monitoring region of a target part of an object to be monitored; performing semantic segmentation on the images to obtain a first region feature of the monitoring region in the images; determining a second region feature of the monitoring region based on a dependency relationship between a plurality of pre-constructed prototypes and the first region feature, where different prototypes are used to characterize different types of monitoring regions; recognizing feature information of the monitoring region based on the first region feature and the second region feature to determine a recognition result of the monitoring region; and outputting the recognition result by calling a second interface, where the second interface comprises a second parameter, and a parameter value of the second parameter is the recognition result.

According to another aspect of an embodiment of this application, an image processing apparatus is further provided, comprising: an acquisition module, configured to acquire a plurality of images, where the display content of the images at least comprises a monitoring region of a target part of an object to be monitored; a segmentation module, configured to perform semantic segmentation on the images to obtain a first region feature of the monitoring region in the images; a first determination module, configured to determine a second region feature of the monitoring region based on a dependency relationship between a plurality of pre-constructed prototypes and the first region feature, where different prototypes are used to characterize different types of monitoring regions; and a second determination module, configured to recognize feature information of the monitoring region based on the first region feature and the second region feature to determine a recognition result of the monitoring region.

According to another aspect of an embodiment of this application, an image processing apparatus is further provided, comprising: a first display module, configured to, in response to an input instruction acting on an operation interface, display a plurality of images on the operation interface, where the display content of the images at least comprises a monitoring region of a target part of an object to be monitored; and a second display module, configured to, in response to an image processing instruction acting on the operation interface, display a recognition result of the monitoring region on the operation interface, where the recognition result is obtained by recognizing feature information of the monitoring region based on a first region feature and a second region feature, the second region feature is determined based on a dependency relationship between a plurality of pre-constructed prototypes and the first region feature, and the first region feature is obtained by performing semantic segmentation on the medical images.

According to another aspect of an embodiment of this application, an image processing apparatus is further provided, comprising: a display module, configured to display a plurality of images on a presentation screen of a virtual reality (VR) device or an augmented reality (AR) device, where the display content of the images at least comprises a monitoring region of a target part of an object to be monitored; a segmentation module, configured to perform semantic segmentation on the images to obtain a first region feature of the monitoring region in the images; a first determination module, configured to determine a second region feature of the monitoring region based on a dependency relationship between a plurality of pre-constructed prototypes and the first region feature, where different prototypes are used to characterize different types of monitoring regions; a second determination module, configured to recognize feature information of the monitoring region based on the first region feature and the second region feature to determine a recognition result of the monitoring region; and a driving module, configured to drive the VR device or the AR device to render and display the recognition result.

According to another aspect of an embodiment of this application, an image processing apparatus is further provided, comprising: an acquisition module, configured to acquire a plurality of images by calling a first interface, where the first interface comprises a first parameter, a parameter value of the first parameter is the plurality of images, and the display content of the images at least comprises a monitoring region of a target part of an object to be monitored; a segmentation module, configured to perform semantic segmentation on the images to obtain a first region feature of the monitoring region in the images; a first determination module, configured to determine a second region feature of the monitoring region based on a dependency relationship between a plurality of pre-constructed prototypes and the first region feature, where different prototypes are used to characterize different types of monitoring regions; a second determination module, configured to recognize feature information of the monitoring region based on the first region feature and the second region feature to determine a recognition result of the monitoring region; and an output module, configured to output the recognition result by calling a second interface, where the second interface comprises a second parameter, and a parameter value of the second parameter is the recognition result.

According to another aspect of an embodiment of this application, an electronic device is further provided, comprising: a memory storing an executable program; and a processor configured to run the program, where when the program is run, the method of any one of the above is executed.

According to another aspect of an embodiment of this application, a computer-readable storage medium is further provided, the computer-readable storage medium comprising a stored executable program, where when the executable program is run, a device where the computer-readable storage medium is located is controlled to execute the method of any one of the above.

According to another aspect of an embodiment of this application, a computer-aided diagnosis method for cancer is further provided, comprising: acquiring a plurality of medical images, where the medical images comprise a target monitoring part of an object to be monitored; performing semantic segmentation on the medical images to obtain a first part feature of the monitoring part in the medical images; determining a second part feature of the monitoring part based on a dependency relationship between a plurality of pre-constructed prototypes and the first part feature, where different prototypes are used to characterize different types of monitoring parts; and diagnosing the monitoring part based on the first part feature and the second part feature to obtain a diagnosis result of the monitoring part, where the diagnosis result is used to characterize that the monitoring part has a malignant condition or a benign condition.

According to another aspect of an embodiment of this application, a computer-aided diagnosis system for cancer is further provided, comprising a memory, a processor, and a computer program stored on the memory and running on the processor, where the processor executes the computer program to perform a computer-aided diagnosis method for cancer, the method comprising: acquiring a plurality of medical images, where the medical images comprise a target monitoring part of an object to be monitored; performing semantic segmentation on the medical images to obtain a first part feature of the monitoring part in the medical images; determining a second part feature of the monitoring part based on a dependency relationship between a plurality of pre-constructed prototypes and the first part feature, where different prototypes are used to characterize different types of monitoring parts; and diagnosing the monitoring part based on the first part feature and the second part feature to obtain a diagnosis result of the monitoring part, where the diagnosis result is used to characterize that the monitoring part is a malignant condition or a benign condition.

According to another aspect of an embodiment of this application, a computer-aided diagnosis method for lung cancer is further provided, comprising: acquiring a plurality of medical images, where the medical images comprise a lung lesion; performing semantic segmentation on the medical images to obtain a first lesion feature of the lung lesion in the medical images; determining a second lesion feature of the lung lesion based on a dependency relationship between a plurality of pre-constructed prototypes and the first nodule feature; where different prototypes are used to characterize different types of lung lesions; and diagnosing the lung lesion based on the first lesion feature and the second lesion feature to obtain a diagnosis result of the lung lesion, where the diagnosis result is used to characterize that the lung lesion is a benign condition or a malignant condition.

According to another aspect of an embodiment of this application, a pulmonary nodule diagnosis method is further provided, comprising: acquiring a plurality of medical images, where the plurality of medical images comprise a pulmonary nodule; performing semantic segmentation on the medical images to obtain a first nodule feature of the pulmonary nodule in the medical images; determining a second nodule feature of the pulmonary nodule based on a dependency relationship between a plurality of pre-constructed prototypes and the first nodule feature, where different prototypes are used to characterize different types of pulmonary nodules; and diagnosing the pulmonary nodule based on the first nodule feature and the second nodule feature to obtain a diagnosis result of the pulmonary nodule, where the diagnosis result is used to characterize that the pulmonary nodule is a benign nodule or malignant nodule.

According to another aspect of an embodiment of this application, a pulmonary nodule diagnosis apparatus is further provided, comprising: an acquisition module, configured to acquire a plurality of medical images, where the plurality of medical images comprise a pulmonary nodule; a segmentation module, configured to perform semantic segmentation on the medical images to obtain a first nodule feature of the pulmonary nodule in the medical images; a determination module, configured to determine a second nodule feature of the pulmonary nodule based on a dependency relationship between a plurality of pre-constructed prototypes and the first nodule feature, where different prototypes are used to characterize different types of pulmonary nodule; and a diagnosis module, configured to diagnose the pulmonary nodule based on the first nodule feature and the second nodule feature to obtain a diagnosis result of the pulmonary nodule, where the diagnosis result is used to characterize that the pulmonary nodule is a benign nodule or a malignant nodule.

According to another aspect of an embodiment of this application, a computer program is further provided, which stores computer-executable instructions that, when executed by a processor, implement the method of any one of the above.

According to another aspect of an embodiment of this application, a computer program product is further provided, comprising a computer program that, when executed on a computer, causes the computer to execute the method of any one of the above. In the embodiments of this application, a method is adopted of: acquiring a plurality of images; performing semantic segmentation on the images to obtain a first region feature of a monitoring region in the images; determining a second region feature of the monitoring region based on a dependency relationship between a plurality of pre-constructed prototypes and the first region feature; and recognizing feature information of the monitoring region based on the first region feature and the second region feature to determine a recognition result of the monitoring region. It can be easily noted that this application not only performs semantic segmentation on the images to obtain region features, but also combines the dependency relationship between the prototypes and the region features, ensuring that the final region features are more in line with the attributes of the target part itself, resulting in higher feature extraction accuracy. This achieves the purpose of more accurately recognizing the target part of the object to be monitored, thereby realizing the technical effect of improving the recognition accuracy of the target part of the object to be monitored, and thus solving the technical problem of low recognition accuracy when recognizing an image to be monitored in related art.

It should be noted that the foregoing general description and the following detailed description are merely for illustration and explanation of this application and do not constitute a limitation on this application.

### BRIEF DESCRIPTION OF THE DRAWINGS

The drawings described herein are provided for a further understanding of this application and constitute a part of this application. The schematic embodiments of this application and their descriptions are used to explain this application and do not constitute an improper limitation on this application. In the drawings:

FIG. 1 is a schematic diagram of a hardware environment of a virtual reality device for an image processing method according to an embodiment of the present application;

FIG. 2 is a structural block diagram of a computing environment for an image processing method according to an embodiment of the present application;

FIG. 3 is a flowchart of an image processing method according to Embodiment 1 of the present application;

FIG. 4 is a schematic diagram of an optional image processing method according to Embodiment 1 of the present application.

FIG. 5 is a flowchart of an image processing method according to Embodiment 2 of the present application;

FIG. 6 is a schematic diagram of an optional operating interface according to Embodiment 2 of the present application;

FIG. 7 is a flowchart of an image processing method according to Embodiment 3 of the present application;

FIG. 8 is a flowchart of an image processing method according to Embodiment 4 of the present application;

FIG. 9 is a flowchart of a pulmonary nodule diagnosis method according to Embodiment 5 of the present application.

FIG. 10 is a schematic diagram of an optional comparison between a reader study and artificial intelligence according to Embodiment 5 of the present application;

FIG. 11 is a structural schematic diagram of an image processing apparatus according to Embodiment 6 of the present application;

FIG. 12 is a structural schematic diagram of an image processing apparatus according to Embodiment 7 of the present application;

FIG. 13 is a structural schematic diagram of an image processing apparatus according to Embodiment 8 of the present application;

FIG. 14 is a structural schematic diagram of an image processing apparatus according to Embodiment 9 of the present application;

FIG. 15 is a structural schematic diagram of a pulmonary nodule diagnosis apparatus according to Embodiment 10 of the present application;

FIG. 16 is a structural block diagram of a computer terminal according to an embodiment of the present application.

### DETAIL DESCRIPTION OF THE EMBODIMENTS

To enable those skilled in the art to better understand the solutions of this application, the technical solutions in the embodiments of this application will be clearly and completely described below with reference to the drawings in the embodiments of this application. Obviously, the described embodiments are only some, but not all, of the embodiments of this application. Based on the embodiments in this application, all other embodiments obtained by a person of ordinary skill in the art without creative efforts shall fall within the protection scope of this application.

It should be noted that terms such as “first” and “second” in the specification and claims of this application and the above drawings are used to distinguish similar objects, and not necessarily to describe a specific order or sequence. It should be understood that the data so used may be interchanged in appropriate circumstances, so that the embodiments of this application described herein can be implemented in an order other than those illustrated or described herein. In addition, the terms “comprising” and “having” and any variations thereof are intended to cover non-exclusive inclusions. For example, a process, method, system, product, or device that comprises a series of steps or units is not necessarily limited to those steps or units that are clearly listed, but may include other steps or units that are not clearly listed or are inherent to such processes, methods, products, or devices.

First, some nouns or terms that appear in the process of describing the embodiments of this application are applicable to the following explanations:

U-Net: comprises a feature extraction network (encoder) for feature extraction to obtain abstract semantic features, and a feature fusion network (decoder) for a process of restoring to the original image size by using the previously encoded abstract features, to finally obtain a segmentation result (mask image), where the feature extraction network and the feature fusion network can be connected to obtain a U-shaped neural network.

Self-attention model: an attention model where the query, key, and value come from the same set of inputs, which can better understand contextual information when processing sequences.

Cross-attention model: an attention model where the key and value are the same but different from the query.

Prototype: images with similar features. Learned images are clustered in a representation space through a clustering algorithm, and the resulting class center serves as the prototype for that class.

### Embodiment 1

According to an embodiment of this application, an image processing method is provided. It should be noted that the steps shown in the flowcharts of the drawings can be executed in a computer system, such as a set of computer-executable instructions, and, although a logical order is shown in the flowcharts, in some cases, the steps shown or described can be executed in a different order than described herein.

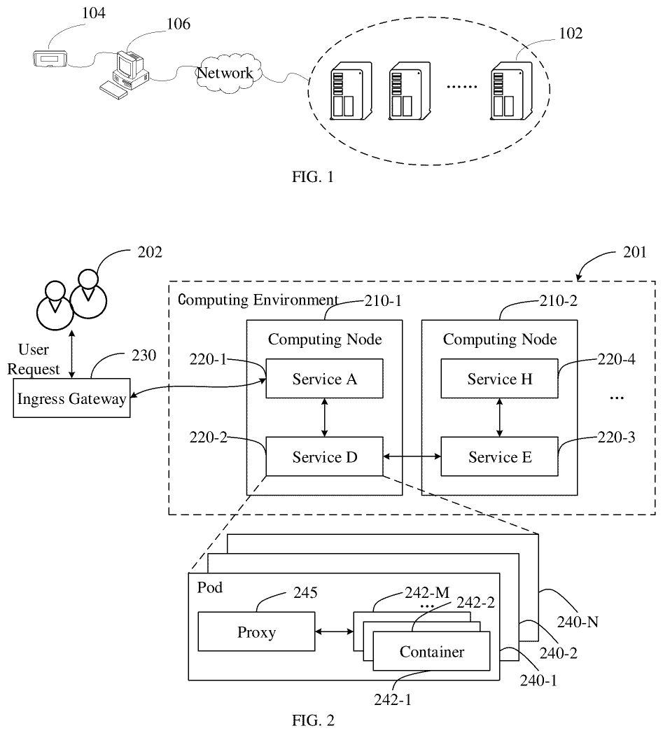

FIG. 1 is a schematic diagram of a hardware environment of a virtual reality device for an image processing method according to an embodiment of the present application. As shown in FIG. 1, a virtual reality device 104 is connected to a terminal 106, and the terminal 106 is connected to a server 102 through a network. The virtual reality device 104 is not limited to a virtual reality helmet, virtual reality glasses, an all-in-one virtual reality machine, etc. The terminal 104 is not limited to a PC, a mobile phone, a tablet computer, etc. The server 102 may be a server corresponding to a media file operator. The network includes but is not limited to a wide area network, a metropolitan area network, or a local area network.

Optionally, the virtual reality device 104 of this embodiment comprises: a memory, a processor, and a transmission device. The memory is used to store an application program, which can be used to execute: acquiring a plurality of images, where the display content of the images at least comprises a monitoring region of a target part of an object to be monitored; performing semantic segmentation on the images to obtain a first region feature of the monitoring region in the images; determining a second region feature of the monitoring region based on a dependency relationship between a plurality of pre-constructed prototypes and the first region feature, where different prototypes are used to characterize different types of monitoring regions; and recognizing feature information of the monitoring region based on the first region feature and the second region feature to determine a recognition result of the monitoring region, thereby solving the technical problem of low recognition accuracy when recognizing an image to be monitored in related art, and achieving the purpose of accurately recognizing the target part of the object to be monitored.

The terminal of this embodiment can be used to execute: displaying a plurality of images on a presentation screen of a virtual reality (Virtual Reality, hereinafter referred to as VR) device or an augmented reality (Augmented Reality, hereinafter referred to as AR) device, where the display content of the images at least comprises a monitoring region of a target part of an object to be monitored; performing semantic segmentation on the images to obtain a first region feature of the monitoring region in the images; determining a second region feature of the monitoring region based on a dependency relationship between a plurality of pre-constructed prototypes and the first region feature, where different prototypes are used to characterize different types of monitoring regions; recognizing feature information of the monitoring region based on the first region feature and the second region feature to determine a recognition result of the monitoring region; and driving the VR device or the AR device to render and display the recognition result.

Optionally, the HMD (Head Mount Display) headset with eye tracking and the eye tracking module of the virtual reality device 104 of this embodiment have the same function as in the above embodiments, that is, a screen in the HMD headset is used to display a real-time picture, and an eye tracking module in the HMD is used to acquire a real-time motion trajectory of a user's eyeball. The terminal of this embodiment acquires position information and motion information of the user in a real three-dimensional space through a tracking system, and calculates three-dimensional coordinates of the user's head in a virtual three-dimensional space, as well as a viewing direction of the user in the virtual three-dimensional space.

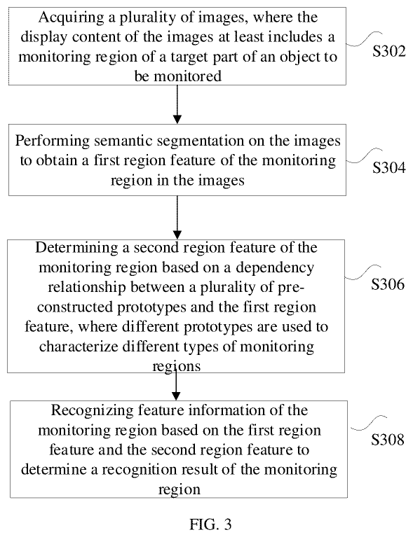

The hardware structural block diagram shown in FIG. 1 can serve not only as an exemplary block diagram of the AR/VR device (or mobile device) but also as an exemplary block diagram of the server. In an optional embodiment, FIG. 2 shows, in a block diagram, an embodiment of using the AR/VR device (or mobile device) shown in FIG. 1 as a computing node in a computing environment 201. FIG. 2 is a structural block diagram of a computing environment for an image processing method according to an embodiment of the present application. As shown in FIG. 2, the computing environment 201 includes multiple computing nodes (such as servers) running on a distributed network (shown as 210-1, 210-2, . . . in the figure). Different computing nodes all include local processing and memory resources. A terminal user 202 can remotely run applications or store data in the computing environment 201. The applications can be provided as multiple services 220-1, 220-2, 220-3, and 220-4 in the computing environment 201, representing services “A”, “D”, “E”, and “H”, respectively.

A terminal user 202 can provide and access services through a web browser or other software applications on a client. In some embodiments, a supply and/or request of the terminal user 202 can be provided to an ingress gateway 230. The ingress gateway 230 may include a corresponding proxy to process the supply and/or request for a service (one or more services provided in a computing environment 201).

Services are provided or deployed according to various virtualization technologies supported by the computing environment 201. In some embodiments, services may be provided according to virtualization based on a virtual machine (Virtual Machine, VM), virtualization based on a container, and/or the like. Virtualization based on a virtual machine can simulate a real computer by initializing a virtual machine to execute programs and applications without directly contacting any actual hardware resources. While a virtual machine virtualizes a machine, according to virtualization based on a container can be started to virtualize an entire operating system (Operating System, OS) so that multiple workloads can run on a single operating system instance.

In an embodiment based on container virtualization, several containers of a service can be assembled into a Pod (for example, a Kubernetes Pod). For example, as shown in FIG. 2, the service 220-2 can be equipped with one or more Pods 240-1, 240-2, . . . , 240-N (collectively referred to as Pods). A Pod can include a proxy 245 and one or more containers 242-1, 242-2, . . . , 242-M (collectively referred to as containers). One or more containers in the Pod process requests related to one or more corresponding functions of the service, and the proxy 245 usually controls network functions related to the service, such as routing, load balancing, etc. Other services can also be equipped with similar Pods.

During operation, executing a user request from the terminal user 202 may require calling one or more services in the computing environment 201, and executing one or more functions of one service requires calling one or more functions of another service. As shown in FIG. 2, service “A” 220-1 receives a user request from the terminal user 202 from an ingress gateway 230. Service “A” 220-1 can call service “D” 220-2, and service “D” 220-2 can request service “E” 220-3 to execute one or more functions.

The computing environment may be a cloud computing environment. The allocation of resources is managed by a cloud service provider, allowing the development of functions without considering the implementation, adjustment, or expansion of servers. The computing environment allows developers to execute code that responds to events without building or maintaining complex infrastructure. Services can be partitioned to complete a set of functions that can be automatically and independently scaled, instead of expanding a single hardware device to handle potential loads.

In the above operating environment, the present application provides an image processing method as shown in FIG. 3. It should be noted that the image processing method of this embodiment can be executed by the mobile terminal of the embodiment shown in FIG. 1. FIG. 3 is a flowchart of an image processing method according to Embodiment 1 of the present application. As shown in FIG. 3, the method may include the following steps:

Step S302, acquiring a plurality of images, where the display content of the images at least includes a monitoring region of a target part of an object to be monitored.

The object to be monitored may be a part of a human body, but is not limited to this, and may also be a part of a building, etc. The target part may be a part of the object to be monitored that needs to be specifically monitored. For example, when the object to be monitored is the lungs of a human body, the target part may be nodules, blood vessels, tracheas, etc. in the lungs, but is not limited to these. When the object to be monitored is a window on a building wall, the target part may be the handle, frame corners, middle part, etc. of the window, but is not limited to these. The monitoring region may be a region containing the target part of the object to be monitored, which can be called a Region Of Interest (ROI).

In an optional embodiment, when it is necessary to monitor a target part of an object to be monitored, an original image comprising the target part of the object to be monitored may first be acquired, and then the original image may be cropped based on a monitoring region to obtain an image of the target part, that is, the above-mentioned plurality of images, where the plurality of images at least comprise the target part of the object to be monitored. For example, when it is necessary to monitor nodules in a human lung, a CT image captured of the lung may first be acquired, where the CT image is a 3-dimensional (Dimensional) image. Then, the CT image may be cropped based on the lung to obtain a 3D cropped image. Then, to be able to perform feature extraction on the 3D cropped image may be converted into a plurality of 2D images (i.e., the plurality of images). As another example, when it is necessary to monitor a window on a building wall, a plurality of original images captured of the window may first be acquired, and then the plurality of original images may be cropped based on the window, that is, the above-mentioned plurality of images can be obtained.

In another optional embodiment, when it is necessary to monitor a target part of an object to be monitored, a video captured of the object to be monitored may first be acquired, and then multiple extractions may be performed on the video to obtain a plurality of original images. Then, the plurality of original images may be cropped based on a monitoring region to obtain a plurality of images of the target part, that is, the above-mentioned plurality of images, where the plurality of images at least comprise the target part of the object to be monitored. For example, when it is necessary to monitor a window on a building wall, a video captured of the window may first be acquired, and then multiple extractions may be performed on the video to obtain a plurality of original images. Then, the plurality of original images may be cropped based on the window, that is, the above-mentioned plurality of images can be obtained.

Step S304, performing semantic segmentation on the images to obtain a first region feature of the monitoring region in the images.

In an optional embodiment, after the images are acquired, semantic segmentation may be performed on the images of the monitoring region through a semantic segmentation model, that is, the first region feature of the monitoring region can be obtained. For example, contextual semantic segmentation may be performed on the images of the monitoring region through a semantic segmentation model, that is, the first region feature of the monitoring region can be obtained. As another example, contextual semantic segmentation may first be performed on the images of the monitoring region through a semantic segmentation model to obtain a preset region feature of the monitoring region, and then contextual parsing may be performed on the preset region feature through the semantic segmentation model, thereby obtaining the first region feature of the monitoring region, but it is not limited to this.

It should be noted that the above-mentioned semantic segmentation model may be any one or more models in related art that can perform semantic segmentation on the images of the monitoring region to obtain the first region feature, which is not specifically limited in this embodiment.

Step S306, determining a second region feature of the monitoring region based on a dependency relationship between a plurality of pre-constructed prototypes and the first region feature, where different prototypes are used to characterize different types of monitoring regions.

The above-mentioned prototypes may be monitoring regions of confirmed types, and the types corresponding to different prototypes are also different. The above-mentioned type may be a type of the target part. For example, when the target part comprised in the monitoring region is a human joint, the type of the monitoring region may be a joint; when the target part comprised in the monitoring region is a building window, the type of the monitoring region may be a window, but it is not limited to this.

In an optional embodiment, a dependency relationship between different prototypes and the first region feature may first be constructed. Then, after the first region feature is obtained, a prototype corresponding to the first region feature may be determined based on the dependency relationship. Then, the first region feature and the prototype corresponding to the first region feature may be processed to obtain the second region feature of the monitoring region.

Step S308, recognizing feature information of the monitoring region based on the first region feature and the second region feature to determine a recognition result of the monitoring region.

The above-mentioned recognition result may be a result obtained after recognizing the target part in the monitoring region. For example, when the target part in the monitoring region is a joint, the recognition result may be that the joint condition is good, or that the joint condition is poor; when the target part in the monitoring region is a window, the recognition result may be that the window meets requirements, or that the window does not meet requirements, but it is not limited to this.

In an optional embodiment, after the first region feature and the second region feature are obtained, feature information of the monitoring region may be recognized based on the first region feature and the second region feature to obtain a recognition result of the monitoring region. For example, the feature information of the monitoring region may be recognized based on the first region feature and the second region feature respectively to obtain a first recognition result and a second recognition result, and then the first recognition result and the second recognition result are compared, and the recognition result with higher accuracy is selected as the final comparison result. As another example, the feature information of the monitoring region may be recognized based on the first region feature and the second region feature respectively to obtain a first recognition result and a second recognition result, and then an average value of the first recognition result and the second recognition result is taken to obtain a final recognition result. As yet another example, the first region feature and the second region feature may first be subjected to feature fusion, and then the feature information of the monitoring region may be recognized based on the fused region feature to obtain the recognition result of the monitoring region, but it is not limited to this.

For example, when it is necessary to monitor nodules in a human lung, a CT image comprising the human lung may first be acquired, and then the CT image may be cropped based on a lung region to obtain a 3D cropped image. Then, to be able to perform feature extraction on the 3D cropped image, the 3D cropped image may be converted into a plurality of 2D images (i.e., the plurality of images), where each of the plurality of images comprises a lung nodule. Contextual semantic segmentation is performed on the lung images through a semantic segmentation model to obtain a preset region feature of the lung images. Then, contextual parsing may also be performed on the preset region feature through the semantic segmentation model, thereby obtaining a first region feature of the lung images. Then, a prototype corresponding to the first region feature may be determined based on a pre-constructed dependency relationship, and the first region feature and the prototype corresponding to the first region feature are processed to obtain a second region feature. Finally, feature information of the lung images may be recognized based on the first region feature and the second region feature respectively to obtain a first recognition result and a second recognition result. Finally, an average value of the first recognition result and the second recognition result may be obtained to get the final recognition result.

In the embodiments of this application, a method is adopted of: acquiring a plurality of images; performing semantic segmentation on the images to obtain a first region feature of a monitoring region in the images; determining a second region feature of the monitoring region based on a dependency relationship between a plurality of pre-constructed prototypes and the first region feature; and recognizing feature information of the monitoring region based on the first region feature and the second region feature to determine a recognition result of the monitoring region. It can be easily noted that this application not only performs semantic segmentation on the images to obtain region features, but also combines the dependency relationship between the prototypes and the region features, ensuring that the final region features are more in line with the attributes of the target part itself, resulting in higher feature extraction accuracy. This achieves the purpose of more accurately recognizing the target part of the object to be monitored, thereby realizing the technical effect of improving the recognition accuracy of the target part of the object to be monitored, and thus solving the technical problem of low recognition accuracy when recognizing an image to be monitored in related art.

In the above embodiments of this application, performing semantic segmentation on the images to obtain the first region feature of the monitoring region in the images comprises: performing semantic segmentation on the images to obtain a semantic segmentation result and a global feature of the images; performing feature fusion on the semantic segmentation result and the images to obtain a fused feature; and performing attention processing on the global feature and the fused feature to obtain the first region feature.

The above-mentioned semantic segmentation result may be a semantic mask M, which can reflect whether a pixel in an image belongs to a target region. When a pixel belongs to the target region, the semantic segmentation result for that pixel may be 1, but is not limited to this, and may also be 0. When the object to be monitored is a human lung, the semantic segmentation result M comprises different voxels (for example: nodules, blood vessels, etc.), belonging to the set {0: background, 1: lung, 2: nodule, 3: blood vessel, 4: trachea}.

In an optional embodiment, semantic segmentation may first be performed on the images through a semantic segmentation module to obtain a semantic segmentation result and a global feature of the images. Then, the semantic segmentation result and the images may be segmented into small blocks based on the target part. Then, feature fusion is performed on the semantic segmentation results and images that have been segmented into small blocks, that is, feature fusion may be performed on the semantic segmentation results and images that have been segmented into small blocks and comprise the same target part to obtain a fused feature. Finally, attention processing may be performed on the global feature and the fused feature, that is, the first region feature can be obtained.

In the above embodiments of this application, performing semantic segmentation on the images to obtain the semantic segmentation result and the global feature of the images comprises: using an encoder module of a U-Net model to perform feature extraction on the images to obtain a first image feature of the images; extracting the global feature from a bottleneck layer of the U-Net model; and using a decoder module of the U-Net model to decode the first image feature to obtain the semantic segmentation result.

In an optional embodiment, feature extraction may first be performed on the images through an encoder module of a U-Net model to obtain a first image feature of the images. Then, the first image feature may be decoded through a decoder module of the U-Net model, that is, a semantic segmentation result can be obtained. In addition, a global feature of the images may also be extracted through a bottleneck layer of the U-Net model, where the bottleneck layer is located in a middle layer of the U-Net model.

In the above embodiments of this application, performing feature fusion on the semantic segmentation result and the images to obtain the fused feature comprises: respectively splitting the semantic segmentation result and the images to obtain a plurality of sub-segmentation results and a plurality of sub-images; respectively performing feature extraction on the plurality of sub-segmentation results and the plurality of sub-images to obtain sub-segmentation features of the plurality of sub-segmentation results and sub-image features of the plurality of sub-images; and fusing the sub-segmentation features and the sub-image features to obtain the fused feature.

In an optional embodiment, after the semantic segmentation result of the images is obtained, the semantic segmentation result and the images may first be split based on the target part to obtain a plurality of sub-segmentation results and a plurality of sub-images, where the plurality of sub-segmentation results and corresponding plurality of sub-images comprise the same target part. Then, feature extraction may be respectively performed on the plurality of sub-segmentation results and the plurality of sub-images to obtain sub-segmentation features of the plurality of sub-segmentation results and sub-image features of the plurality of sub-images. Then, the sub-segmentation features and the sub-image features may be fused to obtain the fused feature.

In the above embodiments of this application, performing attention processing on the global feature and the fused feature to obtain the first region feature comprises: concatenating the global feature and the fused feature to obtain a first concatenated feature; and using a self-attention model to perform self-attention processing on the first concatenated feature to obtain the first region feature.

In an optional embodiment, first, the global feature and the fused feature can be subjected to fragment position insertion (i.e., concatenation), that is, a first concatenated feature token can be obtained as [q; t₁, . . . , t_{g}]∈R^{(g+1)D}, where q is the global feature, t is the fused feature, R is a set of real numbers with a dimension of (g+1)D, D represents an embedding dimension, and g represents the number of fused features.

In another optional embodiment, first, a semantic segmentation result is cut into small image patches, and regions corresponding to an original image are concatenated together; second, a sequence can be generated through image patch encoding and position encoding. At the same time, a high-level semantic feature is extracted from a convolutional neural network as a global feature of a nodule.

In another optional embodiment, after the first concatenated feature is obtained, the first concatenated feature can be subjected to self-attention processing through a self-attention model. For example, the first concatenated feature can be subjected to self-attention processing through a normalization function (Norm), self-attention modeling (Service Component Architecture, SCA), and a feed-forward network (FFN) in the self-attention model, that is, a first regional feature can be obtained.

In the above embodiments of the present application, a second regional feature of a monitoring region is determined based on a dependency relationship between a plurality of pre-constructed prototypes and a first regional feature, comprising: performing attention processing on the first regional feature and the plurality of prototypes by using a cross-attention model to obtain the second regional feature.

In an optional embodiment, attention processing can be performed on the first regional feature and the plurality of prototypes through Norm, a cross-prototype attention (CPA) module, and an FFN in a cross-attention model, that is, the second regional feature can be obtained.

In the above embodiments of the present application, the method further comprises: acquiring global features of different monitoring regions; clustering the global features of the different monitoring regions to obtain a plurality of feature sets; and constructing a plurality of prototypes based on central features of the plurality of feature sets.

In an optional embodiment, first, global features of different monitoring regions can be acquired, and second, the global features can be clustered to obtain a plurality of feature sets {C₁, . . . , C_{N}}, where C represents clustered features, and N represents the number of features.

In another optional embodiment, a plurality of prototypes can be obtained by minimizing an objective function

$${\sum }_{i = 1}^{N} {\sum }_{p ∈ {C}_{i}} d ( p , {P}_{i} )$$

and central features of a plurality of features sets

$${P}_{i} = \frac{1}{\vert {C}_{i} \vert} {\sum }_{p ∈ {C}_{i}} p ,$$

where d is a Euclidean function, and p represents a global feature. It should be noted that a first prototype can be represented as P^{B}∈R^{N/2×D}, and a second prototype can be represented as P^{M}∈R^{N/2×D}.

In the above embodiments of the present application, after determining the second regional feature of the monitoring region based on the dependency relationship between the plurality of pre-constructed prototypes and the first regional feature, the method further comprises: determining, from the plurality of pre-constructed prototypes, a target prototype that successfully matches the second regional feature; performing momentum update on the target prototype to obtain an updated regional feature; and updating the plurality of prototypes based on the updated regional feature.

In an optional embodiment, the target prototype can be subjected to momentum update through the following formula:

$$\{ \begin{matrix}{P}_{{argmin}_{j} d ( q , {P}_{j}^{B} )}^{B} = λ \cdot {P}_{{argmin}_{j} d ( q , {P}_{j}^{B} )}^{B} + ( 1 - λ ) \cdot q \\ {P}_{{argmin}_{j} d ( q , {P}_{j}^{M} )}^{M} = λ \cdot {P}_{{argmin}_{j} d ( q , {P}_{j}^{M} )}^{M} + ( 1 - λ ) \cdot q\end{matrix} ,$$

$$where {P}_{{argmin}_{j} d ( q , {P}_{j}^{B} )}^{B}$$

is the first prototype after momentum update,

$${P}_{{argmin}_{j} d ( q , {P}_{j}^{M} )}^{M}$$

the second prototype after momentum update, λ is a momentum factor, generally set to 0.95, but not limited to this, where the momentum update can help accelerate convergence and improve generalization ability.

In another optional embodiment, after an updated target prototype is obtained, an updated regional feature can be obtained based on the updated target prototype, and then the plurality of prototypes can be updated based on the updated regional feature.

In the above embodiments of the present application, feature information of a monitoring region is identified based on a first regional feature and a second regional feature to determine an identification result of the monitoring region, comprising: identifying the feature information of the monitoring region based on a global feature to obtain a first sub-identification result; identifying the feature information of the monitoring region based on the first regional feature to obtain a second sub-identification result; identifying the feature information of the monitoring region based on the second regional feature to obtain a third sub-identification result; and summarizing the first sub-identification result, the second sub-identification result, and the third sub-identification result to obtain the identification result.

In an optional embodiment, feature information of a detection region can be identified based on a global feature, a first regional feature, and a second regional feature, respectively, through a multi-layer perceptron (MLP), to obtain a first identification result, a second identification result, and a third identification result, respectively. Finally, the first identification result, the second identification result, and the third identification result can be summarized to obtain an identification result. For example, an average value of the first identification result, the second identification result, and the third identification result can be obtained as the identification result, or a more accurate identification result among the first identification result, the second identification result, and the third identification result can be obtained as the identification result, but it is not limited to this.

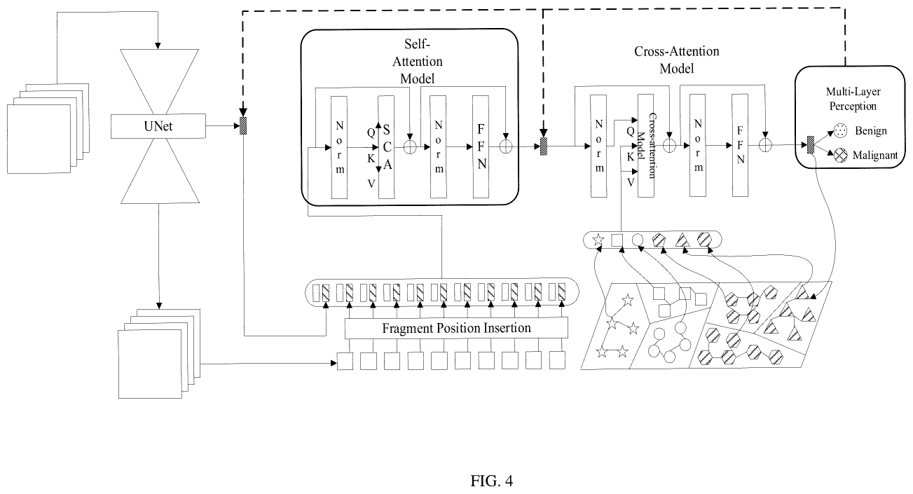

FIG. 4 is a schematic diagram of an optional image processing method according to Embodiment 1 of the present application. As shown in FIG. 4, first, a plurality of images are input into a U-Net neural network model. The U-Net neural network can decode and encode the plurality of images to obtain a semantic segmentation result, and at the same time, the U-Net neural network model can output global features of the plurality of images through a bottleneck layer. Second, the semantic segmentation result and the plurality of images can be partitioned to obtain a plurality of sub-segmentation results and a plurality of sub-images, and feature extraction is performed on the plurality of sub-segmentation results and the plurality of sub-images to obtain a plurality of sub-segmentation features and sub-image features. Then, the plurality of sub-segmentation features and sub-image features can be fused to obtain fused features, as shown by the small white squares in FIG. 4. Then, the global features and the fused features can be concatenated (i.e., block position embedding) to obtain first concatenated features, as shown by the white rectangular blocks and the diagonally shaded rectangular blocks in FIG. 4. Then, the first concatenated features can be input into a self-attention model, and a first region feature is obtained through a normalization function, self-attention modeling, and a feed-forward neural network. Then, the first region feature can be input into a cross-attention model, and a second region feature is obtained through a normalization function, cross-prototype attention, and a feed-forward neural network. Finally, three MLP recognition results can be obtained by mapping from a representation space of the global features, the first region feature, and the second region feature to a class space through an MLP, and finally, a mean of the three MLP recognition results is obtained to get the final recognition result. In the self-attention model, the query, key, and value are the same and come from the same set of inputs, while in the cross-attention model, the query is different from the key and value.

It should be noted that there are multiple feature sets in the parallelograms in the figure, where the polygon connected by the arrow is a prototype. After the prototype is determined, a target prototype that successfully matches the second region feature can be determined. Then, a momentum update is performed on the target prototype to obtain updated region features; based on the updated region features, the multiple prototypes can be updated.

It should be noted that the user information (including but not limited to user device information, user personal information, etc.) and data (including but not limited to data for analysis, stored data, displayed data, etc.) involved in the present application are all information and data that have been authorized by the user or fully authorized by all parties, and the collection, use, and processing of the relevant data need to comply with relevant laws, regulations, and standards of relevant countries and regions, and corresponding operation portals are provided for users to choose to authorize or refuse.

It should be noted that, for the foregoing method embodiments, for the sake of simple description, they are all expressed as a series of action combinations. However, a person skilled in the art should know that the present application is not limited by the described sequence of actions, because according to the present application, some steps may be performed in other orders or simultaneously. Second, a person skilled in the art should also know that the embodiments described in the specification are all preferred embodiments, and the actions and modules involved are not necessarily essential to the present application.

Through the description of the above implementations, a person skilled in the art can clearly understand that the method according to the above embodiments can be implemented by means of software plus a necessary general hardware platform, and of course, can also be implemented by hardware. Based on this understanding, the technical solution of the present application in essence, or the part that contributes to the prior art, can be embodied in the form of a software product. The computer software product is stored in a storage medium (such as ROM/RAM, a magnetic disk, or an optical disc) and includes several instructions to cause a terminal device (which may be a mobile phone, a computer, a server, or a network device, etc.) to execute the methods described in the various embodiments of the present application.

### Embodiment 2

According to an embodiment of the present application, an image processing method is also provided. It should be noted that the steps shown in the flowchart of the drawings can be executed in a computer system such as a set of computer-executable instructions, and, although a logical order is shown in the flowchart, in some cases, the steps shown or described can be executed in an order different from that described herein.

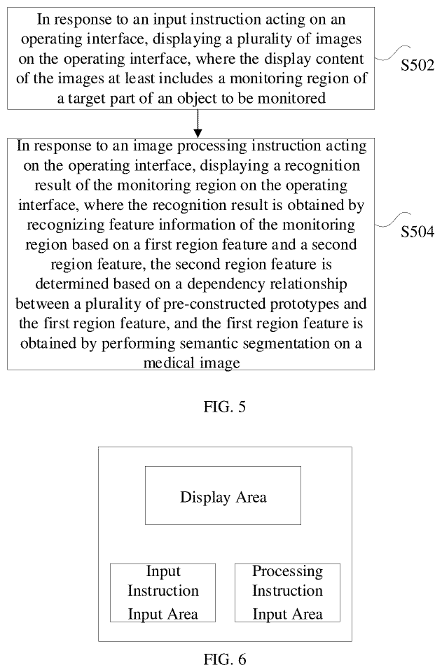

FIG. 5 is a flowchart of an image processing method according to Embodiment 2 of the present application. As shown in FIG. 5, the method may include the following steps:

Step S502, in response to an input instruction acting on an operating interface, displaying a plurality of images on the operating interface, where the display content of the images at least includes a monitoring region of a target part of an object to be monitored;

Step S504, in response to an image processing instruction acting on the operating interface, displaying a recognition result of the monitoring region on the operating interface, where the recognition result is obtained by recognizing feature information of the monitoring region based on a first region feature and second region feature, the second region feature is determined based on a dependency relationship between a plurality of pre-constructed prototypes and the first region feature, and the first region feature is obtained by performing semantic segmentation on the medical images.

FIG. 6 is a schematic diagram of an optional operating interface according to Embodiment 2 of the present application. As shown in FIG. 6, the operating interface includes: an input instruction input area, a processing instruction input area, and a display area. When it is necessary to monitor a target part of an object to be monitored in an image, a display instruction can first be input in the input instruction input area of the operating interface, and the operating interface can then display a plurality of display images in the display area. Second, a processing instruction can be input in the processing instruction input area, and the operating interface can display a recognition result of the monitoring region in the display area, where the recognition result is obtained by recognizing feature information of the monitoring region based on a first region feature and second region feature, the second region feature is determined based on a dependency relationship between a plurality of pre-constructed prototypes and the first region feature, and the first region feature is obtained by performing semantic segmentation on the medical images.

It should be noted that the preferred implementation solutions involved in the above embodiments of the present application are the same as the solution, application scenarios, and implementation process provided in Embodiment 1, but are not limited to the solution provided in Embodiment 1.

### Embodiment 3

According to an embodiment of the present application, an image processing method is also provided, which can be applied to virtual reality scenarios such as virtual reality (VR) devices and augmented reality (AR) devices. It should be noted that the steps shown in the flowchart of the drawings can be executed in a computer system such as a set of computer-executable instructions, and, although a logical order is shown in the flowchart, in some cases, the steps shown or described can be executed in an order different from that described herein.

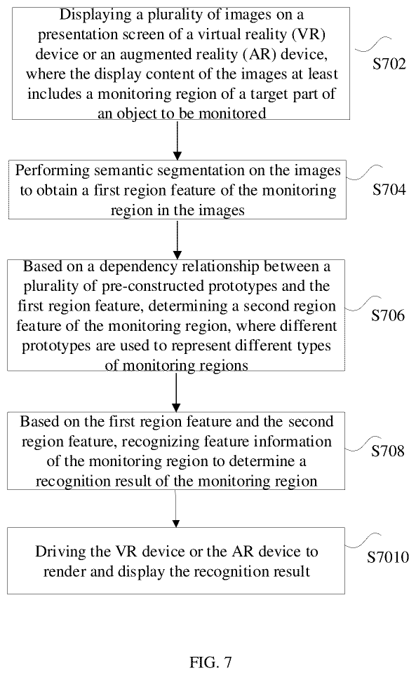

FIG. 7 is a flowchart of an image processing method according to Embodiment 3 of the present application. As shown in FIG. 7, the method may include the following steps:

Step S702, displaying a plurality of images on a presentation screen of a virtual reality (VR) device or an augmented reality (AR) device, where the display content of the images at least includes a monitoring region of a target part of an object to be monitored;

Step S704, performing semantic segmentation on the images to obtain a first region feature of the monitoring region in the images;

Step S706, based on a dependency relationship between a plurality of pre-constructed prototypes and the first region feature, determining a second region feature of the monitoring region, where different prototypes are used to represent different types of monitoring regions;

Step S708, based on the first region feature and the second region feature, recognizing feature information of the monitoring region to determine a recognition result of the monitoring region;

Step S7010, driving the VR device or the AR device to render and display the recognition result.

In an optional embodiment, when a target part of an object to be monitored needs to be monitored, first, a plurality of images can be displayed on a presentation screen of a virtual reality (VR) device or an augmented reality (AR) device, where display content of the images at least includes a monitoring region of the target part of the object to be monitored; second, semantic segmentation can be performed on the images to obtain a first regional feature of the monitoring region in the images; then, a second regional feature of the monitoring region can be determined based on a dependency relationship between a plurality of pre-constructed prototypes and the first regional feature, where different prototypes are used to characterize different types of monitoring regions; then, feature information of the monitoring region can be identified based on the first regional feature and the second regional feature to determine an identification result of the monitoring region; and finally, the VR device or the AR device can be driven to render and display the identification result.

Optionally, in this embodiment, the above image processing method can be applied to a hardware environment composed of a server and a virtual reality device. The identification result is displayed on a presentation screen of a virtual reality (VR) device or an augmented reality (AR) device. The server may be a server corresponding to a media file operator. The network includes but is not limited to: a wide area network, a metropolitan area network, or a local area network. The virtual reality device is not limited to: a virtual reality helmet, virtual reality glasses, an all-in-one virtual reality machine, etc.

Optionally, the virtual reality device comprises: a memory, a processor, and a transmission device. The memory is used for storing an application program, and the application program can be used for executing: displaying a plurality of images on a presentation screen of a virtual reality (VR) device or an augmented reality (AR) device, where display content of the images at least includes a monitoring region of a target part of an object to be monitored; performing semantic segmentation on the images to obtain a first regional feature of the monitoring region in the images; determining a second regional feature of the monitoring region based on a dependency relationship between a plurality of pre-constructed prototypes and the first regional feature, where different prototypes are used to characterize different types of monitoring regions; identifying feature information of the monitoring region based on the first regional feature and the second regional feature to determine an identification result of the monitoring region; and driving the VR device or the AR device to render and display the identification result.

It should be noted that the image processing method applied in a VR device or an AR device in this embodiment may include the method of the embodiment shown in FIG. 3, so as to achieve the purpose of driving the VR device or the AR device to display the recognition result.

Optionally, the processor of this embodiment can call the application program stored in the memory through the transmission device to execute the above steps. The transmission device can receive media files sent by a server through a network, and can also be used for data transmission between the processor and the memory.

Optionally, in the virtual reality device, a head-mounted display with eye tracking, a screen in the HMD headset is used for displaying a video picture, an eye tracking module in the HMD is used for acquiring a real-time motion trajectory of a user's eyeball, a tracking system is used for tracking position information and motion information of the user in a real three-dimensional space, and a computing processing unit is used for acquiring real-time position and motion information of the user from the tracking system, and calculating a three-dimensional coordinate of the user's head in a virtual three-dimensional space, and a field of view orientation of the user in the virtual three-dimensional space, etc.

In an embodiment of the present application, a virtual reality device can be connected to a terminal, and the terminal is connected to a server through a network. The virtual reality device is not limited to: a virtual reality helmet, virtual reality glasses, an all-in-one virtual reality machine, etc. The terminal is not limited to a PC, a mobile phone, a tablet computer, etc. The server may be a server corresponding to a media file operator. The network includes but is not limited to: a wide area network, a metropolitan area network, or a local area network.

It should be noted that the preferred implementation solutions involved in the above embodiments of the present application are the same as the solution, application scenarios, and implementation process provided in Embodiment 1, but are not limited to the solution provided in Embodiment 1.

### Embodiment 4

According to an embodiment of the present application, an image processing method is also provided. It should be noted that the steps shown in the flowchart of the drawings can be executed in a computer system such as a set of computer-executable instructions, and, although a logical order is shown in the flowchart, in some cases, the steps shown or described can be executed in an order different from that described herein.

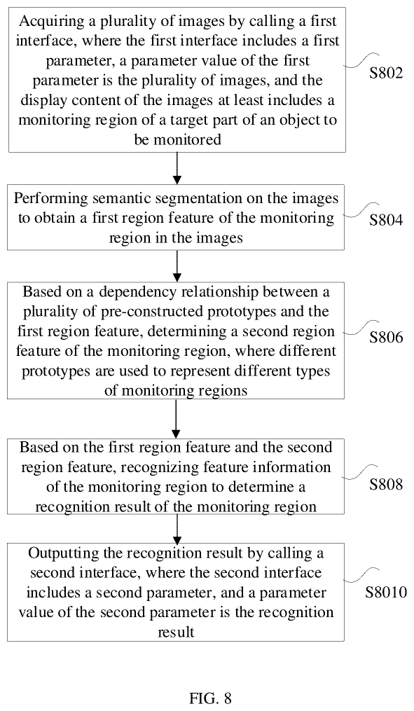

FIG. 8 is a flowchart of an image processing method according to Embodiment 4 of the present application. As shown in FIG. 8, the method may include the following steps:
Step S802, acquiring a plurality of images by calling a first interface, where the first interface includes a first parameter, a parameter value of the first parameter is the plurality of images, and the display content of the images at least includes a monitoring region of a target part of an object to be monitored;
Step S804, performing semantic segmentation on the images to obtain a first region feature of the monitoring region in the images;
Step S806, based on a dependency relationship between a plurality of pre-constructed prototypes and the first region feature, determining a second region feature of the monitoring region, where different prototypes are used to represent different types of monitoring regions;
Step S808, based on the first region feature and the second region feature, recognizing feature information of the monitoring region to determine a recognition result of the monitoring region;
Step S8010, outputting the recognition result by calling a second interface, where the second interface includes a second parameter, and a parameter value of the second parameter is the recognition result.

The first interface may be an interface for acquiring a plurality of images from a server, and the second interface may be an interface for sending the recognition result to the server.

In an optional embodiment, when a target part of an object to be monitored needs to be monitored, first, a plurality of images can be acquired by calling a first interface, where the first interface includes a first parameter, and a parameter value of the first parameter is the plurality of images, and display content of the images at least includes a monitoring region of the target part of the object to be monitored; second, semantic segmentation can be performed on the images to obtain a first regional feature of the monitoring region in the images; then, a second regional feature of the monitoring region can be determined based on a dependency relationship between a plurality of pre-constructed prototypes and the first regional feature, where different prototypes are used to characterize different types of monitoring regions; then, feature information of the monitoring region can be identified based on the first regional feature and the second regional feature to determine an identification result of the monitoring region; and finally, the identification result can be output by calling a second interface, where the second interface includes a second parameter, and a parameter value of the second parameter is the identification result.

It should be noted that the preferred implementation solutions involved in the above embodiments of the present application are the same as the solution, application scenarios, and implementation process provided in Embodiment 1, but are not limited to the solution provided in Embodiment 1.

### Embodiment 5

According to an embodiment of the present application, a pulmonary nodule diagnosis method is also provided. It should be noted that the steps shown in the flowchart of the drawings can be executed in a computer system such as a set of computer-executable instructions, and, although a logical order is shown in the flowchart, in some cases, the steps shown or described can be executed in an order different from that described herein.

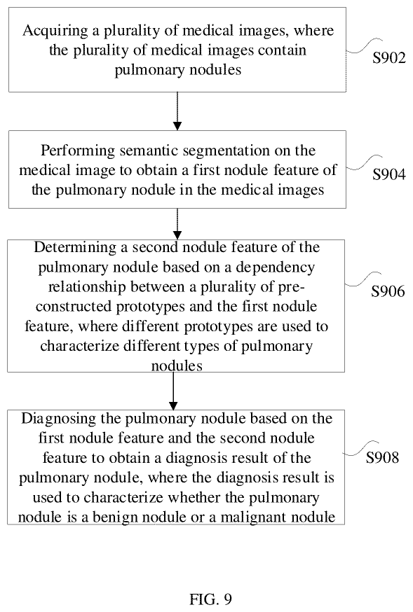

FIG. 9 is a flowchart of a pulmonary nodule diagnosis method according to Embodiment 5 of the present application. As shown in FIG. 9, the method may include the following steps:

Step S902, acquiring a plurality of medical images, where the plurality of medical images contain a pulmonary nodule.

The plurality of medical images may be a plurality of 2D medical images, which are a plurality of 2D images obtained by cropping and converting an ROI region (for example, a lung region) of a computed tomography (CT) image of a human body, where the plurality of medical images contain a pulmonary nodule.

In an optional embodiment, when cancer screening needs to be performed on the lungs, first, a medical image containing a pulmonary nodule can be acquired; second, the medical image can be cropped based on a lung region to obtain a lung image; and finally, the lung image can be converted to obtain a plurality of 2D medical images, where the plurality of medical images contain the pulmonary nodule.

Step S904, performing semantic segmentation on the medical images to obtain a first nodule feature of the pulmonary nodule in the medical images.

In an optional embodiment, after medical images are acquired, first, semantic segmentation can be performed on lung images through a semantic segmentation model, that is, a first nodule feature of a pulmonary nodule can be obtained. For example, contextual semantic segmentation can be performed on the lung images through the semantic segmentation model, that is, the first nodule feature of the pulmonary nodule in the lung images can be obtained. As another example, first, contextual semantic segmentation can be performed on the lung images through the semantic segmentation model to obtain a first preset nodule feature of the pulmonary nodule in the lung images, and second, contextual parsing can also be performed on the first preset nodule feature through the semantic segmentation model, thereby obtaining the first nodule feature of the pulmonary nodule in the lung images, but it is not limited to this.

For example, in a contextual segmentation stage, nodule contextual information has an important impact on benign and malignant diagnosis. For example, nodules associated with blood vessels are more likely to be malignant than isolated nodules. Therefore, a U-shaped neural network (UNet) can be used to parse a semantic mask m (i.e., contextual semantic segmentation images) of the input images (i.e., medical images), where the input images are images obtained by cropping a pulmonary nodule ROI region in an original CT image, and the input is a three-dimensional volume composed of a plurality of 2D images (slices). This allows for subsequent contextual modeling of both the nodule and its surrounding structures. Specifically, each voxel of m belongs to {0: background, 1: lung, 2: nodule, 3: vessel, 4: trachea}. This segmentation process can collect comprehensive contextual information that is crucial for an accurate diagnosis. For the purpose of diagnosis, a global feature can be extracted from a bottleneck of the UNet as a nodule embedding q, which will be used in a later diagnosis stage.

It should be noted that, in the contextual segmentation stage, the contextual content required for benign and malignant distinction of pulmonary nodules includes normal lung tissue, nodules, blood vessels, and trachea. This information not only reflects information such as the shape, position, and size of the nodule itself, but also reflects the structural relationship between the nodule and surrounding tissues. The present application uses a U-shaped convolutional neural network to perform pixel-level identification on the above contextual semantic information, and can finally obtain a contextual semantic segmentation map of each nodule.

Step S906, determining a second nodule feature of the pulmonary nodule based on a dependency relationship between a plurality of pre-constructed prototypes and a first nodule feature, where different prototypes are used to characterize different types of pulmonary nodules.

In one possible embodiment, first, a dependency relationship between different prototypes and the first nodule feature can be constructed; second, after the first nodule feature is obtained, a prototype corresponding to the first nodule feature can be determined based on the dependency relationship; and then, the first nodule feature and the prototype corresponding to the first nodule feature can be processed to obtain a second nodule feature of the pulmonary nodule of the lung images.

For example, in a nodule internal context parsing stage, the present application designs a context parsing module based on an attention mechanism, which is used to deeply analyze a nodule, integrate its contextual information, and improve benign and malignant distinction ability. Specifically, for different nodules, their contextual semantic segmentation images are cut into small image patches, and regions corresponding to an original image (i.e., an input image) are concatenated together to obtain a plurality of overlapping patches. A sequence of contextual features (tokens) is generated through image patch encoding and position encoding. At the same time, a high-level semantic feature is extracted from a convolutional neural network as a global representation of the nodule, also called a nodule token. By designing a contextual self-attention module, a long-range dependency relationship between the nodule token and contextual tokens is modeled, and relevant evidence for benign and malignant distinction is extracted from the contextual information. The nodule token output by the self-attention module serves as a new representation for nodule benign and malignant distinction.

It should be noted that, in the nodule internal context parsing stage, a distinctive representation of a nodule can be enhanced by aggregating contextual information generated by a segmentation model. Specifically, a contextual mask can be tokenized into a set of sequences through overlapping patch embedding. An input image is also divided into small patches and embedded into contextual tokens to preserve original image information. In addition, position encoding is added in a learnable manner to preserve position information. A nodule embedding token can be prepended to a contextual sequence, represented as [q; t₁, . . . , t_{g}]∈R^{(g+1)D}. Here, g is the number of contextual tokens, and D represents an embedding dimension. Then, self-attention modeling, called SCA, can be simultaneously performed on these tokens to aggregate contextual information into the nodule embedding token. The token embedded at the output of the last SCA block is used as an updated nodule representation. Explicitly modeling the dependency between the nodule embedding and its background structures can lead to the evolution of a more distinctive representation, thereby improving the distinction between benign and malignant nodules.

As another example, in a nodule prototype recall learning stage, the present application designs a nodule diagnosis knowledge prototype review module. First, a prototype of a nodule is defined as a representative of nodules with similar features. Learned pulmonary nodules are clustered in a representation space through a clustering algorithm, and the obtained class center is used as the prototype of the category. The prototypes have benign and malignant distinctions; benign prototypes are calculated from benign nodules with similar features, while malignant prototypes are from malignant nodules. To utilize this prototype knowledge, the present application designs a cross-prototype attention module to construct a relationship between a current nodule and other prototypes, where a query is a representation from the current nodule, and a key and a value are representations from the prototypes, respectively. The query token output by the cross-prototype attention module serves as the final representation for benign and malignant distinction.

It should be noted that, to preserve previously acquired knowledge, a more effective method is needed, rather than storing all learned nodules in a memory, which would lead to a waste of storage and computing resources. To simplify this process, related nodules can be condensed into the form of prototypes. For a set of nodules (i.e., a plurality of nodule images), they can be clustered into N groups {C₁, . . . , C_{N}} by minimizing an objective function

$${\sum }_{i = 1}^{N} {\sum }_{p ∈ {C}_{i}} d ( p , {P}_{i} ) ,$$

where d is a Euclidean distance function, and p represents a nodule embedding, and the center of each cluster is used as a prototype. Considering the differences between benign and malignant nodules, the prototypes can be divided into a benign group and a malignant group, represented by P^{B}∈R^{N/2×D} and P^{M}∈R_{N/2×D}. In addition to parsing the internal context, interlayer dependencies between the nodule and external prototypes can also be captured. This enables PARE to explore relevant identification bases beyond a single nodule. To achieve this, the present application designs a cross-prototype attention (CPA) module, which utilizes the nodule embedding as a query and the prototypes as keys and values. It allows the nodule embedding to selectively participate in the most relevant parts of the prototype sequence. The state of the query at the output of the final CPA module serves as the final nodule representation to predict its malignancy label, “benign” (y=0) or “malignant” (y=1). PARE is a model for diagnosing pulmonary nodules proposed in the present application, and the model includes three parts: contextual segmentation, nodule internal context parsing, and nodule prototype recall learning.

It should be noted that the present application can also update the prototypes in an online manner, thereby allowing the prototypes to quickly adapt to changes in nodule embeddings. For a nodule embedding q with data (x, y), its nearest prototype is selected and then updated through the following momentum rule:

$$\{ \begin{matrix}{P}_{{argmin}_{j} d ( q , {P}_{j}^{B} )}^{B} = λ \cdot {P}_{{argmin}_{j} d ( q , {P}_{j}^{B} )}^{B} + ( 1 - λ ) \cdot q , if y = 0 \\ {P}_{{argmin}_{j} d ( q , {P}_{j}^{M} )}^{M} = λ \cdot {P}_{{argmin}_{j} d ( q , {P}_{j}^{M} )}^{M} + ( 1 - λ ) \cdot q , otherwise\end{matrix} ,$$

$$where {P}_{{argmin}_{j} d ( q , {P}_{j}^{B} )}^{B}$$

is the benign prototype after momentum update,

$${P}_{{argmin}_{j} d ( q , {P}_{j}^{M} )}^{M}$$

the malignant prototype after momentum update, λ is a momentum factor, generally set to 0.95, but not limited to this, where the momentum update can help accelerate convergence and improve generalization ability.

Step S908, diagnosing the pulmonary nodule based on the first nodule feature and the second nodule feature to obtain a diagnosis result of the pulmonary nodule, where the diagnosis result is used to characterize whether the pulmonary nodule is a benign nodule or a malignant nodule.

In an optional embodiment, after the first nodule feature and the second nodule feature are obtained, the pulmonary nodule can be diagnosed based on the first nodule feature and the second nodule feature to obtain a diagnosis result of the pulmonary nodule. For example, the pulmonary nodule can be diagnosed based on the first nodule feature and the second nodule feature, respectively, to obtain a first diagnosis result and a second diagnosis result, and then the first diagnosis result and the second diagnosis result are compared, and the diagnosis result with higher accuracy is selected as a final diagnosis result. As another example, the pulmonary nodule can be diagnosed based on the first nodule feature and the second nodule feature, respectively, to obtain a first diagnosis result and a second diagnosis result, and then an average value of the first diagnosis result and the second diagnosis result is taken to obtain a final diagnosis result. As yet another example, first, the first nodule feature and the second nodule feature can be subjected to feature fusion, and second, the pulmonary nodule can be diagnosed based on the fused nodule feature to obtain the diagnosis result of the pulmonary nodule, but it is not limited to this.

It should be noted that the present application designs a deep supervision training mode to improve the benign and malignant distinction ability. Deep supervision signals are respectively applied to a nodule global representation output by a convolutional neural network, a nodule representation output by a self-context attention module, and a nodule representation output by a cross-prototype attention module. By adding a multi-layer perceptron (MLP), mapping is performed from respective representation spaces to two major category spaces of benign and malignant. In an inference scenario, the benign and malignant category probabilities obtained by three MLPs are integrated into a final distinction probability by means of averaging.

The present application proposes a radiologist-inspired method that simulates the diagnostic process of a radiologist and consists of a context parsing module and a prototype review module. The context parsing module first segments the contextual structure of a nodule and then aggregates contextual information for a more comprehensive understanding of the nodule. The prototype review module utilizes prototype-based learning to compress previously learned cases into prototypes for comparative analysis, which are updated online in a momentum manner during training. Based on these two modules, the method of the present application utilizes both the inherent characteristics of a nodule and external knowledge accumulated from other nodules to achieve a reasonable diagnosis. To meet the needs of low-dose and non-contiguous screening, large-scale datasets of 12,852 and 4,029 nodules were collected from low-dose and non-contiguous CTs, respectively, each with a label of pathology or subsequent confirmation. Experiments on several datasets demonstrate that the method of the present application achieves state-of-art screening performance in both low-dose and non-contiguous scenarios.

In the above embodiments of the present application: by means of the dependency relationship between a plurality of pre-constructed prototypes and a first nodule, rich contextual information can be extracted and aggregated from the nodule and its surrounding organ tissues; by pre-compressing learned nodule diagnosis knowledge into prototypes and using them as a reference to assist in diagnosing new nodules, the final regional feature can be more in line with the attributes of the target part itself, and the feature extraction accuracy is higher; and by diagnosing based on the first nodule feature and the second nodule feature, benign and malignant distinction of pulmonary nodules for two major screening scenarios, low-dose and plain scan, can be achieved, improving the versatility of clinical applications.

Table 1 is an ablation comparison of optional hyperparameters according to Embodiment 5 of the present application. In Table 1, the present application investigates the impact of different configurations on the performance of PARE on a validation set, including transformer layers, number of prototypes, embedding dimension, and deep supervision. As can be seen from Table 1, a higher AUC score can be obtained by increasing the number of transformer layers, increasing the number of prototypes, doubling the channel size of token embeddings, or using deep classification supervision. Based on the highest AUC score of 0.931, L=4, N=40, D=256, and DS=True are empirically set in the following experiments. The hyperparameters include: transformer layers (L), number of prototypes (N), embedding dimension (D), and deep supervision (DS).

TABLE 1
Ablation comparison of hyperparameters

| L | N | D | DS | AUC |
|---|---|---|---|---|
| 1 | 20 | 128 | ✓ | 0.912 |
| 2 | 20 | 128 | ✓ | 0.918 |
| 4 | 20 | 128 | ✓ | 0.924 |
| 4 | 10 | 128 | ✓ | 0.920 |
| 4 | 40 | 128 | ✓ | 0.924 |
| 4 | 40 | 256 | ✓ | 0.931 |
| 4 | 40 | 256 | x | 0.926 |

Table 2 shows the effectiveness of different optional modules according to Embodiment 5 of the present application. In Table 2, the present application investigates the ablation study of different methods/modules on a validation set and observes the following results: (1) the pure segmentation method performs better than the pure classification method, mainly because it enables greater supervision at the pixel level, (2) joint segmentation and classification is superior to any single method, indicating the complementary effect of the two tasks, (3) both context parsing and prototype comparison contribute to improving performance on a strong baseline, thereby demonstrating the effectiveness of the two modules, and (4) compared to segmenting only nodules, segmenting more contextual structures (e.g., blood vessels, lungs, and trachea) provides a slight improvement. Here, MT represents multi-task learning. Context: intra-frame context parsing. Prototype: inter-prototype review. * indicates that only the nodule mask is used in the segmentation task.

TABLE 2
Effectiveness of Different Modules

| Method | AUC |
|---|---|
| Pure classification | 0.907 |
| Pure segmentation | 0.915 |
| MT | 0.916 |
| MT + Context* | 0.921 |
| MT + Context | 0.924 |
| MT + Context + Prototype | 0.931 |

Comparison with other methods on two screening scenarios: Table 3 is a comparison of different methods on the NNLST and an in-house test set according to Embodiment 5 of the present application, including pure classification-based methods, pure segmentation-based methods, and multi-task-based methods. Based on the nodule size distribution, a stratified evaluation is performed in the two test groups. These results indicate that the segmentation-based method outperforms the pure classification method, mainly due to its superior ability to segment contextual structures. In addition, the multi-task-based CA-Net outperforms any single-task method. On the NLST and in-house test sets, the PARE method of the present application surpasses most other methods. Furthermore, by utilizing an ensemble of multiple deep supervision heads, the overall AUC is further improved to 0.931 for both datasets. Here, † represents pure classification; ‡ represents pure segmentation; ⋄ represents multi-task learning; * represents an ensemble of deep supervision heads. It should be noted that: the present application adds a segmentation task to CA-Net.

TABLE 3
Comparison of Different Methods on the NNLST and In-house Test Sets

| | NLST test set | | | | In-house test set | | | |
|---|---|---|---|---|---|---|---|---|
| Method | <10 mm | 10~20 mm | >20 mm | All | <10 mm | 10~20 mm | >20 mm | All |
| CNN† | 0.742 | 0.706 | 0.780 | 0.894 | 0.851 | 0.797 | 0.744 | 0.901 |
| ASPP[5]† | 0.798 | 0.716 | 0.801 | 0.902 | 0.854 | 0.788 | 0.743 | 0.901 |
| MiT[24]† | 0.821 | 0.755 | 0.810 | 0.908 | 0.858 | 0.784 | 0.751 | 0.904 |
| nnUnet[8]‡ | 0.815 | 0.736 | 0.815 | 0.910 | 0.863 | 0.804 | 0.750 | 0.911 |
| CA-Net[12]⋄ | 0.833 | 0.759 | 0.807 | 0.916 | 0.878 | 0.786 | 0.779 | 0.918 |
| PARE⋄ | 0.882 | 0.770 | 0.826 | 0.928 | 0.892 | 0.817 | 0.783 | 0.927 |
| PARE⋄* | 0.890 | 0.781 | 0.827 | 0.931 | 0.899 | 0.821 | 0.780 | 0.931 |

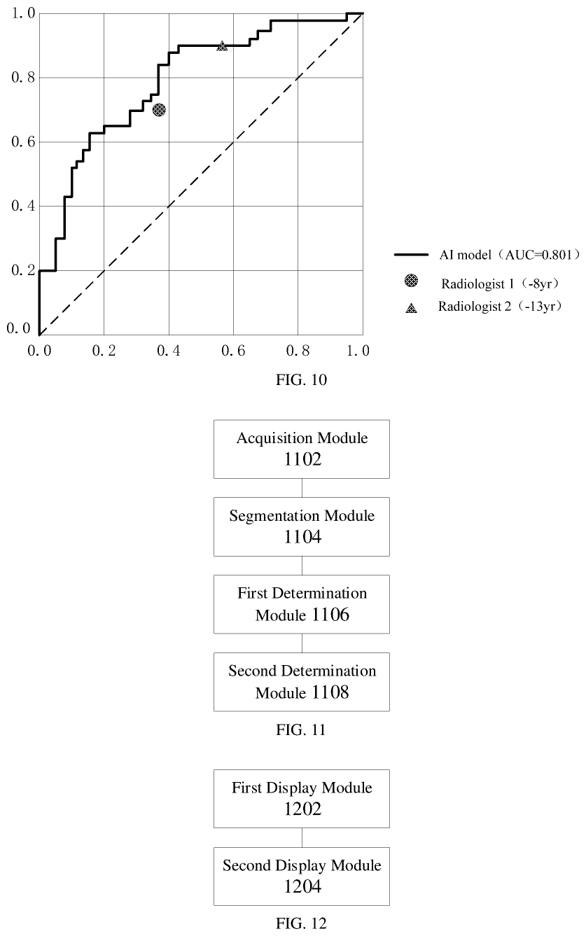

External evaluation of LUNGx: The present application uses LUNGx as an external validation to evaluate the generalization of PARE. It is worth noting that these compared methods have never been trained on LUNGx. Table 4 is an optional comparison with other methods on LUNGx according to Embodiment 5 of the present application. As can be seen from Table 4, the PARE model of the present application has the highest AUC of 0.801, which is a 2% improvement over the DAR method. The present application also conducted a reader study, comparing PARE with two highly experienced radiologists with 8 and 13 years of experience in pulmonary nodule diagnosis, respectively. FIG. 10 is a schematic diagram of an optional comparison between a reader study and artificial intelligence according to Embodiment 5 of the present application. The results in FIG. 3 show that the method of the present application achieves performance comparable to that of radiologists.

TABLE 4
Comparison with other methods on LUNGx

| Method | AUC |
|---|---|
| NLNL[9] | 0.683 |
| CIRDataset[6] | 0.743 |
| D2CNN[25] | 0.746 |
| KBC[23] | 0.768 |
| DAR[11] | 0.781 |
| PARE (Ours) | 0.801 |

It should be noted that the user information (including but not limited to user device information, user personal information, etc.) and data (including but not limited to data for analysis, stored data, displayed data, etc.) involved in the present application are all information and data that have been authorized by the user or fully authorized by all parties, and the collection, use, and processing of the relevant data need to comply with relevant laws, regulations, and standards of relevant countries and regions, and corresponding operation portals are provided for users to choose to authorize or refuse.

Generalization on LDCT and NCCT: The model of the present application is trained on a mixture of LDCT and NCCT datasets and can perform well in both low-dose and normal-dose applications. Table 5 shows a comparison of the generalization performance of models obtained under three training configurations. As can be seen from Table 5, models trained separately on the LDCT or NCCT dataset do not generalize well to the other modality, with at least a 6% drop in AUC. However, the mixed training method of the present application performs best on both LDCT and NCCT, with almost no performance degradation.

TABLE 5
Comparison of the impact of different training
configurations on LDCT and NCCT performance

| Training | Testing Scenario | | Performance Gap Between |
|---|---|---|---|
| Scenario | LDCT | NCCT | the Two Scenarios |
| LDCT | 0.927 | 0.867 | 6.0% |
| NCCT | 0.802 | 0.893 | 9.1% |
| LDCT + NCCT | 0.928 | 0.927 | 0.1% |

Furthermore, by comparing the segmentation results from the LIDC-IDRI data annotated by semantic masks generated by physicians and by TotalSegmentator with the segmentation results annotated by the nodule masks used in the segmentation task provided by embodiments of the present application, PARE achieves a Dice score of 77.9% on 2630 nodules of LIDC-IDRI.

It should be noted that the preferred implementation solutions involved in the above embodiments of the present application are the same as the solution, application scenarios, and implementation process provided in Embodiment 1, but are not limited to the solution provided in Embodiment 1.

### Embodiment 6

According to an embodiment of the present application, a computer-aided cancer diagnosis method is also provided, the method comprising:
acquiring a plurality of medical images, where the medical images comprise a target monitoring part of an object to be monitored;
performing semantic segmentation on the medical images to obtain a first part feature of the monitoring part in the medical images;
determining a second part feature of the monitoring part based on a dependency relationship between a plurality of pre-constructed prototypes and the first part feature, where different prototypes are used to represent different types of monitoring parts;
diagnosing the monitoring part based on the first part feature and the second part feature to obtain a diagnosis result of the monitoring part, where the diagnosis result is used to represent whether the monitoring part is a malignant condition or a benign condition.

It should be noted that the preferred implementation solutions involved in the above embodiments of the present application are the same as the solution, application scenarios, and implementation process provided in Embodiment 1, but are not limited to the solution provided in Embodiment 1.

### Embodiment 7

According to an embodiment of the present application, a computer-aided diagnosis system for cancer is also provided, comprising a memory, a processor, and a computer program stored on the memory and executed on the processor, where the processor executing the computer program can be used to perform a computer-aided method for cancer, the method comprising:
acquiring a plurality of medical images, where the medical images comprise a target monitoring part of an object to be monitored;
performing semantic segmentation on the medical images to obtain a first part feature of the monitoring part in the medical images;
determining a second part feature of the monitoring part based on a dependency relationship between a plurality of pre-constructed prototypes and the first part feature, where different prototypes are used to represent different types of monitoring parts;
diagnosing the monitoring part based on the first part feature and the second part feature to obtain a diagnosis result of the monitoring part, where the diagnosis result is used to represent whether the monitoring part is a malignant condition or a benign condition.

It should be noted that the preferred implementation solutions involved in the above embodiments of the present application are the same as the solution, application scenarios, and implementation process provided in Embodiment 1, but are not limited to the solution provided in Embodiment 1.

### Embodiment 8

According to another aspect of an embodiment of the present application, a computer-aided diagnosis method for lung cancer is also provided, comprising:
acquiring a plurality of medical images, where the medical images comprise a pulmonary lesion;
performing semantic segmentation on the medical images to obtain a first lesion feature of the pulmonary lesion in the medical images;
determining a second lesion feature of the pulmonary lesion based on a dependency relationship between a plurality of pre-constructed prototypes and the first nodule feature, where different prototypes are used to represent different types of pulmonary lesion;
diagnosing the pulmonary nodule based on the first lesion feature and the second lesion feature to obtain a diagnosis result of the pulmonary lesion, where the diagnosis result is used to represent whether the pulmonary lesion is a benign condition or a malignant condition.

In this embodiment, the pulmonary lesion may include a pulmonary nodule. If the diagnosis result is that the pulmonary lesion is a malignant condition, the pulmonary lesion may be caused by lung cancer, so that a doctor or a diagnostic device can determine a treatment plan based on the diagnosis result.

### Embodiment 9

According to an embodiment of the present application, an image processing apparatus for implementing the above image processing method is also provided. FIG. 11 is a structural schematic diagram of an image processing apparatus according to Embodiment 6 of the present application. As shown in FIG. 11, the apparatus includes: an acquisition module 1102, a segmentation module 1104, a first determination module 1106, and a second determination module 1108.

The acquisition module is configured to acquire a plurality of images, where the display content of the images at least includes a monitoring region of a target part of an object to be monitored; the segmentation module is configured to perform semantic segmentation on the images to obtain a first region feature of the monitoring region in the images; the first determination module is configured to, based on a dependency relationship between a plurality of pre-constructed prototypes and the first region feature, determine a second region feature of the monitoring region, where different prototypes are used to represent different types of monitoring regions; the second determination module is configured to, based on the first region feature and the second region feature, recognize feature information of the monitoring region to determine a recognition result of the monitoring region.

It should be noted here that the aforementioned acquisition module, segmentation module, first determination module, and second determination module correspond to steps S302 to S308 in Embodiment 1. The four modules have the same implementation examples and application scenarios as the corresponding steps, but are not limited to the content disclosed in the aforementioned Embodiment 1. It should be noted that the aforementioned modules or units may be hardware components or software components stored in a memory and processed by one or more processors, and the aforementioned modules may also be part of a device and can run on the AR/VR device provided in Embodiment 1.

In the aforementioned embodiments of the present application, the segmentation module comprises: a segmentation unit, a fusion unit, and a first processing unit.

Specifically, the segmentation unit is configured to perform semantic segmentation on the images to obtain a semantic segmentation result and global features of the images; the fusion unit is configured to perform feature fusion on the semantic segmentation result and the images to obtain fused features; and the first processing unit is configured to perform attention processing on the global features and the fused features to obtain a first region feature.

In the aforementioned embodiments of the present application, the segmentation unit comprises: a first extraction subunit, a second extraction subunit, and a decoding subunit.

Specifically, the first extraction subunit is configured to use an encoder module of a U-shaped neural network model to perform feature extraction on the images to obtain a first image feature of the images; the second extraction subunit is configured to extract global features from a bottleneck layer of the U-shaped neural network model; and the decoding subunit is configured to use the encoder module of the U-shaped neural network model to decode the first image feature to obtain a semantic segmentation result.

In the aforementioned embodiments of the present application, the fusion unit comprises: a splitting subunit, a third extraction subunit, and a fusion subunit.

Specifically, the splitting subunit is configured to respectively split the semantic segmentation result and the images to obtain a plurality of sub-segmentation results and a plurality of sub-images; the third extraction subunit is configured to respectively perform feature extraction on the plurality of sub-segmentation results and the plurality of sub-images to obtain sub-segmentation features of the plurality of sub-segmentation results and sub-image features of the plurality of sub-images; and the fusion subunit is configured to fuse the sub-segmentation features and the sub-image features to obtain fused features.

In the aforementioned embodiments of the present application, the first processing unit comprises: a concatenation subunit and a processing subunit.

Specifically, the concatenation subunit is configured to concatenate the global features and the fused features to obtain first concatenated features; and the processing subunit is configured to use a self-attention model to perform self-attention processing on the first concatenated features to obtain a first region feature.

In the aforementioned embodiments of the present application, the first determination module comprises: a second processing unit.

Specifically, the second processing unit is configured to use a cross-attention model to perform attention processing on the first region feature and a plurality of prototypes to obtain a second region feature.

In the aforementioned embodiments of the present application, the first determination module further comprises: an acquisition unit, a clustering unit, and a construction unit.

Specifically, the acquisition unit is configured to acquire global features of different monitoring regions; the clustering unit is configured to perform clustering on the global features of the different monitoring regions to obtain a plurality of feature sets; and the construction unit is configured to construct a plurality of prototypes based on central features of the plurality of feature sets.

In the aforementioned embodiments of the present application, after determining the second region feature of the monitoring region based on a dependency relationship between a plurality of pre-constructed prototypes and the first region feature, the device further comprises: a third determination module, a first update module, and a second update module.

Specifically, the third determination module is configured to determine, from the plurality of pre-constructed prototypes, a target prototype that successfully matches the second region feature; the first update module is configured to perform a momentum update on the target prototype to obtain updated region features; and the second update module is configured to update the plurality of prototypes based on the updated region features.

In the aforementioned embodiments of the present application, the second determination module comprises: a third processing unit, a fourth processing unit, a fifth processing unit, and a summarization unit.

Specifically, the third processing unit is configured to identify feature information of the monitoring region based on the global features to obtain a first sub-identification result; the fourth processing unit is configured to identify feature information of the monitoring region based on the first region feature to obtain a second sub-identification result; the fifth processing unit is configured to identify feature information of the monitoring region based on the second region feature to obtain a third sub-identification result; and the summarization unit is configured to summarize the first sub-identification result, the second sub-identification result, and the third sub-identification result to obtain an identification result.

It should be noted that the preferred implementation solutions involved in the above embodiments of the present application are the same as the solution, application scenarios, and implementation process provided in Embodiment 1, but are not limited to the solution provided in Embodiment 1.

### Embodiment 10

According to an embodiment of the present application, an image processing device for implementing the above image processing method is also provided.

FIG. 12 is a structural schematic diagram of an image processing apparatus according to Embodiment 7 of the present application. As shown in FIG. 12, the apparatus includes: a first display module 1202 and a second display module 1204.

The first display module is configured to, in response to an input instruction acting on an operating interface, display a plurality of images on the operating interface, where the display content of the images at least includes a monitoring region of a target part of an object to be monitored; the second display module is configured to, in response to an image processing instruction acting on the operating interface, display a recognition result of the monitoring region on the operating interface, where the recognition result is obtained by recognizing feature information of the monitoring region based on a first region feature and second region feature, the second region feature are determined based on a dependency relationship between a plurality of pre-constructed prototypes and the first region feature, and the first region feature is obtained by performing semantic segmentation on the medical images.

It should be noted here that the aforementioned first display module and second display module correspond to steps S502 to S504 in Embodiment 2. The two modules have the same implementation examples and application scenarios as the corresponding steps, but are not limited to the content disclosed in the aforementioned Embodiment 2. It should be noted that the aforementioned modules or units may be hardware components or software components stored in a memory and processed by one or more processors, and the aforementioned modules may also be part of a device and can run on the AR/VR device provided in Embodiment 1.

It should be noted that the preferred implementation solutions involved in the above embodiments of the present application are the same as the solution, application scenarios, and implementation process provided in Embodiment 1, but are not limited to the solution provided in Embodiment 1.

### Embodiment 11

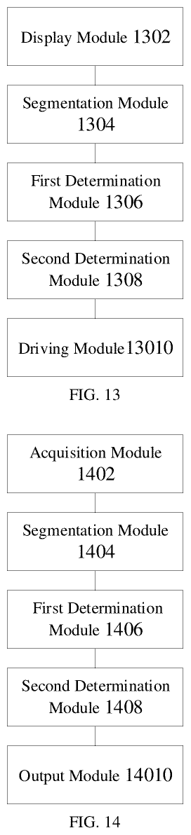

According to an embodiment of the present application, an image processing apparatus for implementing the above image processing method is also provided. FIG. 13 is a structural schematic diagram of an image processing apparatus according to Embodiment 8 of the present application. As shown in FIG. 13, the apparatus includes: a display module 1302, a segmentation module 1304, a first determination module 1306, a second determination module 1308, and a driving module 13010.

The display module is configured to display a plurality of images on a presentation screen of a virtual reality (VR) device or an augmented reality (AR) device, where the display content of the images at least includes a monitoring region of a target part of an object to be monitored; the segmentation module is configured to perform semantic segmentation on the images to obtain a first region feature of the monitoring region in the images; the first determination module is configured to, based on a dependency relationship between a plurality of pre-constructed prototypes and the first region feature, determine a second region feature of the monitoring region, where different prototypes are used to represent different types of monitoring regions; the second determination module is configured to, based on the first region feature and the second region feature, recognize feature information of the monitoring region to determine a recognition result of the monitoring region; the driving module is configured to drive the VR device or the AR device to render and display the recognition result.

It should be noted here that the aforementioned display module, segmentation module, first determination module, second determination module, and driving module correspond to steps S702 to S7010 in Embodiment 3. The five modules have the same implementation examples and application scenarios as the corresponding steps, but are not limited to the content disclosed in the aforementioned Embodiment 3. It should be noted that the aforementioned modules or units may be hardware components or software components stored in a memory and processed by one or more processors, and the aforementioned modules may also be part of a device and can run on the AR/VR device provided in Embodiment 1.

It should be noted that the preferred implementation solutions involved in the above embodiments of the present application are the same as the solution, application scenarios, and implementation process provided in Embodiment 1, but are not limited to the solution provided in Embodiment 1.

### Embodiment 12

According to an embodiment of the present application, an image processing apparatus for implementing the above image processing method is also provided. FIG. 14 is a structural schematic diagram of an image processing apparatus according to Embodiment 9 of the present application. As shown in FIG. 14, the apparatus includes: an acquisition module 1402, a segmentation module 1404, a first determination module 1406, a second determination module 1408, and an output module 14010.

The acquisition module is configured to acquire a plurality of images by calling a first interface, where the first interface includes a first parameter, a parameter value of the first parameter is the plurality of images, and the display content of the images at least includes a monitoring region of a target part of an object to be monitored; the segmentation module is configured to perform semantic segmentation on the images to obtain a first region feature of the monitoring region in the images; the first determination module is configured to, based on a dependency relationship between a plurality of pre-constructed prototypes and the first region feature, determine a second region feature of the monitoring region, where different prototypes are used to represent different types of monitoring regions; the second determination module is configured to, based on the first region feature and the second region feature, recognize feature information of the monitoring region to determine a recognition result of the monitoring region; the output module is configured to output the recognition result by calling a second interface, where the second interface includes a second parameter, and a parameter value of the second parameter is the recognition result.

It should be noted here that the aforementioned acquisition module, segmentation module, first determination module, second determination module, and output module correspond to steps S802 to S8010 in Embodiment 4. The five modules have the same implementation examples and application scenarios as the corresponding steps, but are not limited to the content disclosed in the aforementioned Embodiment 4. It should be noted that the aforementioned modules or units may be hardware components or software components stored in a memory and processed by one or more processors, and the aforementioned modules may also be part of a device and can run on the AR/VR device provided in Embodiment 1.

It should be noted that the preferred implementation solutions involved in the above embodiments of the present application are the same as the solution, application scenarios, and implementation process provided in Embodiment 1, but are not limited to the solution provided in Embodiment 1.

### Embodiment 13

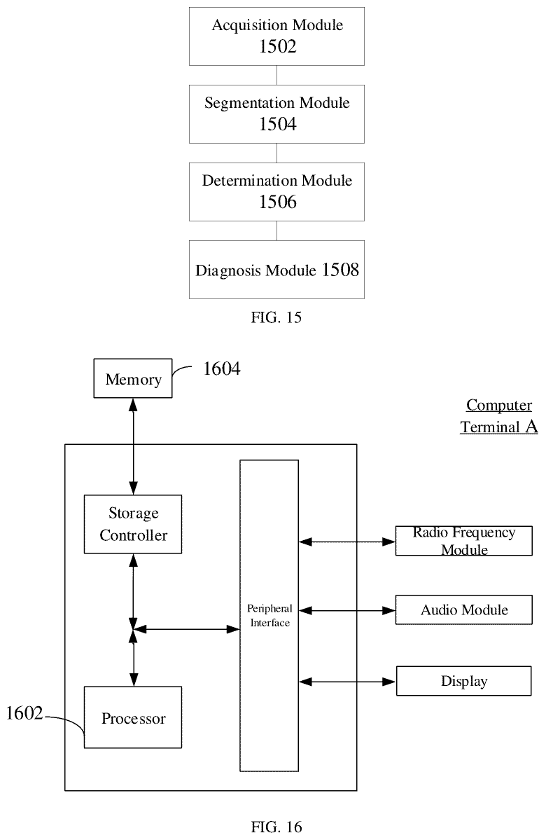

According to an embodiment of the present application, a pulmonary nodule diagnosis apparatus for implementing the above pulmonary nodule diagnosis method is also provided. FIG. 15 is a structural schematic diagram of a pulmonary nodule diagnosis apparatus according to Embodiment 10 of the present application. As shown in FIG. 15, the apparatus includes: an acquisition module 1502, a segmentation module 1504, a determination module 1506, and a diagnosis module 1508.

The acquisition module is configured to acquire a plurality of medical images, where the plurality of medical images contain a pulmonary nodule; the segmentation module is configured to perform semantic segmentation on the medical images to obtain a first nodule feature of the pulmonary nodule in the medical images; the determination module is configured to, based on a dependency relationship between a plurality of pre-constructed prototypes and the first nodule feature, determine a second nodule feature of the pulmonary nodule, where different prototypes are used to represent different types of pulmonary nodules; the diagnosis module is configured to, based on the first nodule feature and the second nodule feature, diagnose the pulmonary nodule to obtain a diagnosis result of the pulmonary nodule, where the diagnosis result is used to indicate whether the pulmonary nodule is a benign nodule or malignant nodule.

It should be noted here that the aforementioned acquisition module, segmentation module, determination module, and diagnosis module correspond to steps S902 to S908 in Embodiment 5. The five modules have the same implementation examples and application scenarios as the corresponding steps, but are not limited to the content disclosed in the aforementioned Embodiment 5. It should be noted that the aforementioned modules or units may be hardware components or software components stored in a memory and processed by one or more processors, and the aforementioned modules may also be part of a device and can run on the AR/VR device provided in Embodiment 1.

It should be noted that the preferred implementation solutions involved in the above embodiments of the present application are the same as the solution, application scenarios, and implementation process provided in Embodiment 1, but are not limited to the solution provided in Embodiment 1.

### Embodiment 14

An embodiment of the present application may provide an AR/VR device, which may be any AR/VR device in a group of AR/VR devices. Optionally, in this embodiment, the AR/VR device may also be replaced with a terminal device such as a mobile terminal.

Optionally, in this embodiment, the AR/VR device may be located in at least one of a plurality of network devices of a computer network.

In this embodiment, the AR/VR device may execute program code for the following steps in the image processing method: displaying a plurality of images on a presentation screen of a virtual reality (VR) device or an augmented reality (AR) device, where display content of the images includes at least a monitoring region of a target part of an object to be monitored; performing semantic segmentation on the images to obtain a first region feature of the monitoring region in the images; determining a second region feature of the monitoring region based on a dependency relationship between a plurality of pre-constructed prototypes and the first region feature, where different prototypes are used to characterize different types of monitoring regions; identifying feature information of the monitoring region based on the first region feature and the second region feature to determine an identification result of the monitoring region; and driving the VR device or the AR device to render and display the identification result.

Optionally, FIG. 16 is a structural block diagram of a computer terminal according to an embodiment of the present application. As shown in FIG. 16, the computer terminal A may include: one or more (only one is shown in the figure) processors 1602, a memory 1604, a storage controller, and a peripheral interface, where the peripheral interface is connected to a radio frequency module, an audio module, and a display.

The memory may be used to store software programs and modules, such as program instructions/modules corresponding to the image processing method and device in the embodiments of the present application. The processor executes various functional applications and data processing, i.e., implements the above image processing method, by running the software programs and modules stored in the memory may include a high-speed random access memory, and may also include a non-volatile memory, such as one or more magnetic storage devices, flash memory, or other non-volatile solid-state memories. In some examples, the memory may further include a memory remotely located relative to the processor, and these remote memories may be connected to a terminal A via a network. Examples of the network include, but are not limited to, the Internet, an enterprise intranet, a local area network, a mobile communication network, and combinations thereof.

The processor may call information and application programs stored in the memory through a transmission device to execute the following steps: acquiring a plurality of images, where display content of the images includes at least a monitoring region of a target part of an object to be monitored; performing semantic segmentation on the images to obtain a first region feature of the monitoring region in the images; determining a second region feature of the monitoring region based on a dependency relationship between a plurality of pre-constructed prototypes and the first region feature, where different prototypes are used to characterize different types of monitoring regions; and identifying feature information of the monitoring region based on the first region feature and the second region feature to determine an identification result of the monitoring region.

Optionally, the processor may also execute program code for the following steps: performing semantic segmentation on the images to obtain a semantic segmentation result and global features of the images; performing feature fusion on the semantic segmentation result and the images to obtain fused features; and performing attention processing on the global features and the fused features to obtain the first region feature.

Optionally, the processor may also execute program code for the following steps: using an encoder module of a U-shaped neural network model to perform feature extraction on the images to obtain a first image feature of the images; extracting global features from a bottleneck layer of the U-shaped neural network model; and using the encoder module of the U-shaped neural network model to decode the first image feature to obtain a semantic segmentation result.

Optionally, the processor may also execute program code for the following steps: respectively splitting the semantic segmentation result and the images to obtain a plurality of sub-segmentation results and a plurality of sub-images; respectively performing feature extraction on the plurality of sub-segmentation results and the plurality of sub-images to obtain sub-segmentation features of the plurality of sub-segmentation results and sub-image features of the plurality of sub-images; and fusing the sub-segmentation features and the sub-image features to obtain fused features.

Optionally, the processor may also execute program code for the following steps: concatenating the global features and the fused features to obtain first concatenated features; and using a self-attention model to perform self-attention processing on the first concatenated features to obtain the first region feature.

Optionally, the processor may also execute program code for the following steps: using a cross-attention model to perform attention processing on the first region feature and a plurality of prototypes to obtain second region feature.

Optionally, the processor may also execute program code for the following steps: acquiring global features of different monitoring regions; performing clustering on the global features of the different monitoring regions to obtain a plurality of feature sets; and constructing a plurality of prototypes based on central features of the plurality of feature sets.

Optionally, the processor may also execute program code for the following steps: determining, from the plurality of pre-constructed prototypes, a target prototype that successfully matches the second region feature; performing a momentum update on the target prototype to obtain updated region features; and updating the plurality of prototypes based on the updated region features.

Optionally, the processor may also execute program code for the following steps: identifying feature information of the monitoring region based on the global features to obtain a first sub-identification result; identifying feature information of the monitoring region based on the first region feature to obtain a second sub-identification result; identifying feature information of the monitoring region based on the second region feature to obtain a third sub-identification result; and summarizing the first sub-identification result, the second sub-identification result, and the third sub-identification result to obtain an identification result.

By adopting the embodiments of the present application, a method is provided for: acquiring a plurality of images; performing semantic segmentation on the images to obtain a first region feature of a monitoring region in the images; determining a second region feature of the monitoring region based on a dependency relationship between a plurality of pre-constructed prototypes and the first region feature; and identifying feature information of the monitoring region based on the first region feature and the second region feature to determine an identification result of the monitoring region. It can be easily noted that the present application not only performs semantic segmentation on the images to obtain region features, but also combines the dependency relationship between the prototypes and the region features to ensure that the final region features are more in line with the attributes of the target part itself, resulting in higher feature extraction accuracy, thereby achieving the purpose of more accurately identifying the target part of the object to be monitored. This achieves the technical effect of improving the identification accuracy of the target part of the object to be monitored, and thus solves the technical problem in related art of low identification accuracy when identifying an image to be monitored.

A person of ordinary skill in the art can understand that the structure shown in the figure is only schematic. The computer terminal may also be a terminal device such as a smartphone (e.g., an Android phone, an iOS phone, etc.), a tablet computer, a personal digital assistant, a Mobile Internet Device (MID), or a PAD. FIG. 16 does not limit the structure of the electronic device. For example, the computer terminal A may also include more or fewer components (such as a network interface, a display device, etc.) than those shown in FIG. 16, or have a different configuration from that shown in FIG. 16.

A person of ordinary skill in the art can understand that all or some of the steps in the various methods of the above embodiments can be implemented by a program instructing relevant hardware of a terminal device. The program can be stored in a computer-readable storage medium, which may include: a flash drive, a read-only memory (ROM), a random access memory (RAM), a magnetic disk, or an optical disc, etc.

### Embodiment 14

An embodiment of the present application also provides a computer-readable storage medium. Optionally, in this embodiment, the computer-readable storage medium may be used to store program code executed by the image processing method provided in Embodiment 1.

Optionally, in this embodiment, the computer-readable storage medium may be located in any computer terminal in a group of AR/VR device terminals in an AR/VR device network, or in any mobile terminal in a group of mobile terminals.

Optionally, in this embodiment, the computer-readable storage medium is configured to store program code for executing the following steps: acquiring a plurality of images, where display content of the images includes at least a monitoring region of a target part of an object to be monitored; performing semantic segmentation on the images to obtain a first region feature of the monitoring region in the images; determining a second region feature of the monitoring region based on a dependency relationship between a plurality of pre-constructed prototypes and the first region feature, where different prototypes are used to characterize different types of monitoring regions; and identifying feature information of the monitoring region based on the first region feature and the second region feature to determine an identification result of the monitoring region.

Optionally, in this embodiment, the computer-readable storage medium is also configured to store program code for executing the following steps: performing semantic segmentation on images to obtain a semantic segmentation result and global features of the images; performing feature fusion on the semantic segmentation result and the images to obtain fused features; and performing attention processing on the global features and the fused features to obtain a first region feature.

Optionally, in this embodiment, the computer-readable storage medium is also configured to store program code for executing the following steps: using an encoder module of a U-shaped neural network model to perform feature extraction on images to obtain a first image feature of the images; extracting global features from a bottleneck layer of the U-shaped neural network model; and using the encoder module of the U-shaped neural network model to decode the first image features to obtain a semantic segmentation result.

Optionally, in this embodiment, the computer-readable storage medium is also configured to store program code for executing the following steps: respectively splitting the semantic segmentation result and the images to obtain a plurality of sub-segmentation results and a plurality of sub-images; respectively performing feature extraction on the plurality of sub-segmentation results and the plurality of sub-images to obtain sub-segmentation features of the plurality of sub-segmentation results and sub-image features of the plurality of sub-images; and fusing the sub-segmentation features and the sub-image features to obtain fused features.

Optionally, in this embodiment, the computer-readable storage medium is also configured to store program code for executing the following steps: concatenating the global features and the fused features to obtain first concatenated features; and using a self-attention model to perform self-attention processing on the first concatenated features to obtain a first region feature.

Optionally, in this embodiment, the computer-readable storage medium is also configured to store program code for executing the following steps: using a cross-attention model to perform attention processing on the first region feature and a plurality of prototypes to obtain second region feature.

Optionally, in this embodiment, the computer-readable storage medium is also configured to store program code for executing the following steps: acquiring global features of different monitoring regions; performing clustering on the global features of the different monitoring regions to obtain a plurality of feature sets; and constructing a plurality of prototypes based on central features of the plurality of feature sets.

Optionally, in this embodiment, the computer-readable storage medium is also configured to store program code for executing the following steps: determining, from the plurality of pre-constructed prototypes, a target prototype that successfully matches the second region feature; performing a momentum update on the target prototype to obtain updated region features; and updating the plurality of prototypes based on the updated region features.

Optionally, in this embodiment, the computer-readable storage medium is also configured to store program code for executing the following steps: identifying feature information of the monitoring region based on the global features to obtain a first sub-identification result; identifying feature information of the monitoring region based on the first region feature to obtain a second sub-identification result; identifying feature information of the monitoring region based on the second region feature to obtain a third sub-identification result; and summarizing the first sub-identification result, the second sub-identification result, and the third sub-identification result to obtain an identification result.

### Embodiment 15

An embodiment of the present application also provides a computer program product, comprising a computer program, where when the computer program is executed on a computer, the computer is caused to execute the method provided by the embodiments of the present application.

### Embodiment 16

An embodiment of the present application also provides a computer program, where when the computer program is executed on a computer, the computer is caused to execute the method provided by the embodiments of the present application. The serial numbers of the above embodiments of the present application are for description only and do not represent the merits of the embodiments.

In the above embodiments of the present application, the descriptions of the various embodiments each have their own emphasis. For parts not detailed in a certain embodiment, reference may be made to the relevant descriptions in other embodiments.

In the several embodiments provided in the present application, it should be understood that the disclosed technical content can be implemented in other ways. The device embodiments described above are merely illustrative. For example, the division of the units is only a logical functional division, and there may be other division methods in actual implementation. For example, a plurality of units or components may be combined or integrated into another system, or some features may be ignored or not executed. In addition, the mutual coupling or direct coupling or communication connections shown or discussed may be indirect coupling or communication connections through some interfaces, units, or modules, and may be in electrical or other forms.

The units described as separate components may or may not be physically separate, and the components displayed as units may or may not be physical units, i.e., they may be located in one place or may be distributed over a plurality of network units. Some or all of the units may be selected according to actual needs to achieve the objectives of the solutions of this embodiment.

In addition, the functional units in the various embodiments of the present application may be integrated into one processing unit, or each unit may exist separately and physically, or two or more units may be integrated into one unit. The integrated units described above can be implemented in the form of hardware or in the form of software functional units.

If the integrated unit is implemented in the form of a software functional unit and sold or used as an independent product, it can be stored in a computer-readable storage medium. Based on this understanding, the technical solution of the present application in essence, or the part that contributes to the prior art, or all or part of the technical solution, can be embodied in the form of a software product. The computer software product is stored in a storage medium and includes several instructions to cause a computer device (which may be a personal computer, a server, or a network device, etc.) to execute all or part of the steps of the methods described in the various embodiments of the present application. The aforementioned storage medium includes: a USB flash drive, a read-only memory (ROM), a random access memory (RAM), a mobile hard disk, a magnetic disk, an optical disc, and various other media that can store program code.

The foregoing descriptions are merely preferred embodiments of the present application. It should be noted that for a person of ordinary skill in the art, several improvements and modifications can be made without departing from the principles of the present application, and these improvements and modifications should also be considered within the protection scope of the present application.

What is claimed is:

1. An image processing method, comprising:
acquiring a plurality of images, wherein display content of the plurality of images includes at least a monitoring region of a target part of an object to be monitored;
performing semantic segmentation on the plurality of images to obtain a first region feature of the monitoring region in the plurality of images;
determining a second region feature of the monitoring region based on a dependency relationship between a plurality of pre-constructed prototypes and the first region feature, wherein different prototypes are used to represent different types of monitoring regions;
identifying feature information of the monitoring region based on the first region feature and the second region feature to determine an identification result of the monitoring region.

2. The method of claim 1, wherein performing semantic segmentation on the plurality of images to obtain the first region feature of the monitoring region in the plurality of images comprises:
performing semantic segmentation on the plurality of images to obtain a semantic segmentation result and a global feature of the plurality of images;
performing feature fusion on the semantic segmentation result and the plurality of images to obtain a fused feature;
performing attention processing on the global feature and the fused feature to obtain the first region feature.

3. The method of claim 2, wherein performing semantic segmentation on the plurality of images to obtain the semantic segmentation result and the global feature of the plurality of images comprises:
using an encoder module of a U-shaped neural network model to perform feature extraction on the plurality of images to obtain a first image feature of the plurality of images;
extracting the global feature from a bottleneck layer of the U-shaped neural network model;
using the encoder module of the U-shaped neural network model to decode the first image feature to obtain the semantic segmentation result.

4. The method of claim 2, wherein performing feature fusion on the semantic segmentation result and the plurality of images to obtain the fused feature comprises:
respectively partitioning the semantic segmentation result and the plurality of images to obtain a plurality of sub-segmentation results and a plurality of sub-images;
respectively performing feature extraction on the plurality of sub-segmentation results and the plurality of sub-images to obtain sub-segmentation features of the plurality of sub-segmentation results and sub-image features of the plurality of sub-images;
fusing the sub-segmentation features and the sub-image features to obtain the fused feature.

5. The method of claim 2, wherein performing attention processing on the global feature and the fused feature to obtain the first region feature comprises:
concatenating the global feature and the fused feature to obtain a first concatenated feature;
using a self-attention model to perform self-attention processing on the first concatenated feature to obtain the first region feature.

6. The method of claim 1, wherein determining a second region feature of the monitoring region based on a dependency relationship between a plurality of pre-constructed prototypes and the first region feature comprises:
using a cross-attention model to perform attention processing on the first region feature and the plurality of pre-constructed prototypes to obtain the second region feature.

7. The method of claim 6, wherein the method further comprises:
acquiring global features of the different monitoring regions;
clustering the global features of the different monitoring regions to obtain a plurality of feature sets;
constructing prototypes to form the plurality of pre-constructed prototypes based on center features of the plurality of feature sets.

8. The method of claim 1, wherein after determining the second region feature of the monitoring region based on the dependency relationship between the plurality of pre-constructed prototypes and the first region feature, the method further comprises:
determining, from the plurality of pre-constructed prototypes, a target prototype that successfully matches the second region feature;
performing a momentum update on the target prototype to obtain an updated region feature;
updating the plurality of pre-constructed prototypes based on the updated region feature.

9. The method of claim 1, wherein identifying feature information of the monitoring region based on the first region feature and the second region feature to determine an identification result of the monitoring region comprises:
identifying the feature information of the monitoring region based on a global feature to obtain a first sub-identification result;
identifying the feature information of the monitoring region based on the first region feature to obtain a second sub-identification result;
identifying the feature information of the monitoring region based on the second region feature to obtain a third sub-identification result;
aggregating the first sub-identification result, the second sub-identification result, and the third sub-identification result to obtain the identification result.

10. An image processing method, comprising:
in response to an input instruction acting on an operating interface, displaying a plurality of images on the operating interface, wherein display content of the plurality of images comprises at least a monitoring region of a target part of an object to be monitored;
in response to an image processing instruction acting on the operating interface, displaying an identification result of the monitoring region on the operating interface, wherein the identification result is obtained by identifying feature information of the monitoring region based on a first region feature and a second region feature, the second region feature is determined based on a dependency relationship between a plurality of pre-constructed prototypes and the first region feature, and the first region feature is obtained by performing semantic segmentation on the plurality of images.

11. The method of claim 10, wherein performing semantic segmentation on the plurality of images comprises:
performing semantic segmentation on the plurality of images to obtain a semantic segmentation result and a global feature of the plurality of images;
performing feature fusion on the semantic segmentation result and the plurality of images to obtain a fused feature;
performing attention processing on the global feature and the fused feature to obtain the first region feature.

12. The method of claim 10, wherein the second region feature is determined based on a dependency relationship between a plurality of pre-constructed prototypes and the first region feature comprises the second region feature is determined based on a dependency relationship between a plurality of pre-constructed prototypes and the first region feature by using a cross-attention model to perform attention processing on the first region feature and the plurality of pre-constructed prototypes.

13. The method of claim 10, wherein identifying feature information of the monitoring region based on the first region feature and the second region feature comprises:
identifying the feature information of the monitoring region based on a global feature to obtain a first sub-identification result;
identifying the feature information of the monitoring region based on the first region feature to obtain a second sub-identification result;
identifying the feature information of the monitoring region based on the second region feature to obtain a third sub-identification result;
aggregating the first sub-identification result, the second sub-identification result, and the third sub-identification result to obtain the identification result.

14. An image processing system, comprising:
one or more processors; and
one or more computer-readable memories coupled to the one or more processors and having instructions stored thereon that are executable by the one or more processors to perform one or more operations comprising:
acquiring a plurality of images, wherein display content of the plurality of images includes at least a monitoring region of a target part of an object to be monitored;
performing semantic segmentation on the plurality of images to obtain a first region feature of the monitoring region in the plurality of images;
determining a second region feature of the monitoring region based on a dependency relationship between a plurality of pre-constructed prototypes and the first region feature, wherein different prototypes are used to represent different types of monitoring regions;
identifying feature information of the monitoring region based on the first region feature and the second region feature to determine an identification result of the monitoring region.

15. The image processing system of claim 14, wherein performing semantic segmentation on the plurality of images to obtain the first region feature of the monitoring region in the plurality of images comprises:
performing semantic segmentation on the plurality of images to obtain a semantic segmentation result and a global feature of the plurality of images;
performing feature fusion on the semantic segmentation result and the plurality of images to obtain a fused feature;
performing attention processing on the global feature and the fused feature to obtain the first region feature.

16. The image processing system of claim 15, wherein performing semantic segmentation on the plurality of images to obtain the semantic segmentation result and the global feature of the plurality of images comprises:
using an encoder module of a U-shaped neural network model to perform feature extraction on the plurality of images to obtain a first image feature of the plurality of images;
extracting the global feature from a bottleneck layer of the U-shaped neural network model;
using the encoder module of the U-shaped neural network model to decode the first image feature to obtain the semantic segmentation result.

17. The image processing system of claim 14, wherein determining a second region feature of the monitoring region based on a dependency relationship between a plurality of pre-constructed prototypes and the first region feature comprises:
using a cross-attention model to perform attention processing on the first region feature and the plurality of pre-constructed prototypes to obtain the second region feature.

18. The image processing system of claim 17, wherein the operations further comprise:
acquiring global features of the different monitoring regions;
clustering the global features of the different monitoring regions to obtain a plurality of feature sets;
constructing prototypes to form the plurality of pre-constructed prototypes based on center features of the plurality of feature sets.

19. The image processing system of claim 14, wherein after determining the second region feature of the monitoring region based on the dependency relationship between the plurality of pre-constructed prototypes and the first region feature, the operations further comprise:
determining, from the plurality of pre-constructed prototypes, a target prototype that successfully matches the second region feature;
performing a momentum update on the target prototype to obtain an updated region feature;
updating the plurality of pre-constructed prototypes based on the updated region feature.

20. The image processing system of claim 14, wherein identifying feature information of the monitoring region based on the first region feature and the second region feature to determine an identification result of the monitoring region comprises:
identifying the feature information of the monitoring region based on a global feature to obtain a first sub-identification result;
identifying the feature information of the monitoring region based on the first region feature to obtain a second sub-identification result;
identifying the feature information of the monitoring region based on the second region feature to obtain a third sub-identification result;
aggregating the first sub-identification result, the second sub-identification result, and the third sub-identification result to obtain the identification result.
